(19) United States
(12) Patent Application Publication
(10) Pub. No.: US 2018/0279241 A1
(43) Pub. Date: Sep. 27, 2018

(54) METHOD AND APPARATUS FOR PBCH TRANSMISSION IN A MULTI-BEAM BASED SYSTEM

(71) Applicant: Samsung Electronics Co., Ltd, Suwon-si (KR)

(72) Inventors: Namjeong LEE, Suwon-si (KR); Jaewon KIM, Seoul (KR); Hyunkyu YU, Suwon-si (KR)

(21) Appl. No.: 15/934,820

(22) Filed: Mar. 23, 2018

(30) Foreign Application Priority Data
Mar. 23, 2017 (KR) 10-2017-0037234
May 4, 2017 (KR) 10-2017-0056966
May 25, 2017 (KR) 10-2017-0064897
Aug. 10, 2017 (KR) 10-2017-0101910

(51) Int. Cl. H04W 56/00; H04L 5/00; H04W 72/04

(52) U.S. Cl. CPC H04W 56/001; H04W 72/044; H04L 5/0048

(57) ABSTRACT

The present disclosure relates to a 5G or pre-5G communication system to be provided to support a higher data transmission rate since 4G communication systems like LTE. According to an embodiment of the present disclosure, a method for transmitting a synchronization signals block (SS block) and a physical broadcasting signal block in a base station of a multi-beam based system includes: identifying, by the base station, the number of bits of an index for indicating the synchronization signals block based on the total number of synchronization signals block (SS block) transmitted within an SS block burst set period; and transmitting the index through DMRS of the physical broadcasting channel (PBCH) if the number of bits of the index is equal to or less than 3.

### CROSS-REFERENCE TO RELATED APPLICATION(S)

This application is based on and claims priority under 35 U.S.C. § 119 to Korean Patent Application No. 10-2017-0037234 filed on Mar. 23, 2017; Korean Patent Application No. 10-2017-0056966 filed on May 4, 2017; Korean Patent Application No. 10-2017-0064897 filed on May 25, 2017; and Korean Patent Application No. 10-2017-0101910 filed on Aug. 10, 2017, in the Korean Intellectual Property Office, the disclosures of which are incorporated herein by reference in their entireties.

### TECHNICAL FIELD

Various embodiments of the present disclosure relate to operations of a base station and a terminal for various PBCH transmission periods in a beamforming system. In addition, the present disclosure includes operations of a base station and a terminal according to a method for transmitting a block including a synchronization signal and a PBCH. Further, the present disclosure also includes contents of a SS block structure.

### BACKGROUND

To meet a demand for radio data traffic that is on an increasing trend since commercialization of a 4G communication system, efforts to develop an improved 5G communication system or a pre-5G communication system have been conducted. For this reason, the 5G communication system or the pre-5G communication system is called a beyond 4G network communication system or a post LTE system.

To achieve a high data transmission rate, the 5G communication system is considered to be implemented in a very high frequency (mmWave) band (e.g., like 60 GHz band). To relieve a path loss of a radio wave and increase a transfer distance of the radio wave in the very high frequency band, in the 5G communication system, beamforming, massive MIMO, full dimensional MIMO (FD-MIMO), array antenna, analog beam-forming, and large scale antenna technologies have been discussed.

Further, to improve a network of the system, in the 5G communication system, technologies such as an evolved small cell, an advanced small cell, a cloud radio access network (cloud RAN), an ultra-dense network, a device to device communication (D2D), a wireless backhaul, a moving network, cooperative communication, coordinated multi-points (CoMP), and reception interference cancellation have been developed.

In addition to this, in the 5G system, hybrid FSK and QAM modulation (FQAM) and sliding window superposition coding (SWSC) that are an advanced coding modulation (ACM) scheme and a filter bank multi carrier (FBMC), a non orthogonal multiple access (NOMA), and a sparse code multiple access (SCMA) that are an advanced access technology, and so on have been developed.

### SUMMARY

Accordingly, embodiments of the present disclosure are directed to the provision of operations of a base station and a terminal according to various physical broadcast channel (PBCH) transmission periods in a multi-beam based system. In particular, the present disclosure provides a method of obtaining system frame number (SFN) and slot/half-frame timing index information of a terminal.

Another object of the present disclosure is directed to provision of an operation on the assumption of a synchronous signal (SS) period for each terminal (RRC_CONNECTED/RRC_IDLE) state.

Another object of the present disclosure is directed to provision of transmission and reception operations of information provided from a base station and a synchronization signal of a terminal and a PBCH decoding operation according to a method for transmitting a block including a synchronization signal and a PBCH.

Another object of the present disclosure is directed to provision of an SS block design.

Objects of the present disclosure are not limited to the above-mentioned objects. That is, other objects that are not mentioned may be obviously understood by those skilled in the art to which the present disclosure pertains from the following description.

Various embodiments of the present disclosure are directed to the provision of a method for transmitting a synchronization signals block (SS block) and a physical broadcasting signal block in a base station of a multi-beam based system, including: identifying, by the base station, the number of bits of an index for indicating the synchronization signals block based on the total number of synchronization signals block (SS block) transmitted within an SS block burst set period; and transmitting the index through DMRS of the physical broadcasting channel (PBCH) if the number of bits of the index is equal to or less than 3.

Various embodiments of the present disclosure are directed to the provision of a base station apparatus for transmitting a synchronization signals block (SS block) and a physical broadcasting signal block in a multi-beam based system, including: a base station transmitter configured to transmit a signal including the synchronization signals block ad a physical broadcasting channel (PBCH) into a base station area based on a multi beam; and at least one processor configured to control the base station to identify the number of bits of an index for indicating the synchronization signals block based on the total number of synchronization signals block (SS block) transmitted within an SS block burst set period; and transmit the index through DMRS of the physical broadcasting channel (PBCH) if the number of bits of the index is equal to or less than 3.

Various embodiments of the present disclosure are directed to the provision of a method for receiving a synchronization signals block (SS block) and a physical broadcasting signal block in a terminal of a multi-beam based system, including: identifying the total number of synchronization signals block (SS block) transmitted within a synchronization signals block (SS block) burst set period based on a frequency accessing the base station; receiving a physical broadcasting channel (PBCH) from the base station; identifying whether the number of bits of a synchronization signals block identifier is equal to or less than 3 based on the total number of synchronization signals blocks; and determining the synchronization signals block (SS block) identifier using a scrambling sequence of DMRS of the PBCH if the number of bits of a synchronization signals block identifier is equal to or less than 3.

Various embodiments of the present disclosure are directed to the provision of a terminal apparatus for receiving a synchronization signals block (SS block) and a physical broadcasting signal block in a multi-beam based system, including: a terminal transmitter configured to receive a signal including the synchronization signals block and a physical broadcasting channel (PBCH); and at least one processor configured to: identify the total number of synchronization signals block (SS block) transmitted within a synchronization signals block (SS block) burst set period based on a frequency accessing the base station, control the terminal transmitter to receive the PBCH from the base station, identify whether the number of bits of a synchronization signals block identifier is equal to or less than 3 based on the total number of synchronization signals blocks, and determine the synchronization signals block (SS block) identifier using a scrambling sequence of the DMRS of the PBCH if the number of bits of a synchronization signals block identifier is equal to or less than 3.

It is possible to efficiently and clearly obtain the SNF information and the half-frame timing index information in the system in which one base station can select one of various PBCH transmission periods, based on the method for designing the scrambling sequence for the PBCH decoding and the method for obtaining the SFN and half-frame timing index information of the terminal according to the embodiment of the present disclosure. In addition, it is possible to clearly know the location of the block including the synchronization signal and the PBCH upon the initial access of the terminal based on the base station providing information on the method for transmitting the block including the synchronization signal and the PBCH according to the embodiment of the present disclosure.

The effects that may be achieved by the embodiments of the present disclosure are not limited to the above-mentioned objects. That is, other effects that are not mentioned may be obviously understood by those skilled in the art to which the present disclosure pertains from the following description.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document. Those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram illustrating a transmission of an SS block and an SS burst set;

FIG. 2 illustrates a diagram in which an initial access terminal-based SS burst set period is larger than a base station setting SS burst set period, and an SS burst set is transmitted in a base station setting SS burst set period;

FIG. 3 illustrates a diagram in which the initial access terminal-based SS burst set period is smaller than the base station setting SS burst set period, and the SS burst set is transmitted in the base station setting SS burst set period;

FIG. 4 illustrates a diagram in which the initial access terminal-based SS burst set period is smaller than the base station setting SS burst set period, and the SS burst set is transmitted in the terminal-based SS burst set period upon the initial access;

FIG. 5 is a diagram illustrating a transmission of an SS slot and an SS block according to the present disclosure;

FIG. 6 is a diagram illustrating a combination of method-1 and method 2-1-1 as an embodiment of the SS burst set transmission operation in the base station according to the present disclosure;

FIG. 7 is a diagram illustrating a combination of the method-1 and the method 2-1-1 as an embodiment for obtaining a slot start point, an SS burst set start point, a half-frame timing index, and a system frame number in a terminal according to the present disclosure;

FIG. 8 is a diagram illustrating method 3-1 as another embodiment of the SS burst set transmission operation in the base station according to the present disclosure;

FIG. 9 is a diagram illustrating the method 3-1 and the method 2-1-1 as another embodiment for obtaining the slot start point, the SS burst set start point, the half-frame timing index, and the system frame number in a terminal according to the present disclosure;

FIG. 10 is a diagram illustrating a combination of method-5-1 and method 2-2 as the embodiment of the SS burst set transmission operation in the base station according to the present disclosure;

FIG. 11 is a diagram illustrating a combination of the method-5-1 and the method 2-2-1 as another embodiment for obtaining the slot start point, the SS burst set start point, the half-frame timing index, and the system frame number in the terminal according to the present disclosure;

FIG. 12 is a diagram illustrating a combination of the method-5-1 and method 2-10 as the embodiment of the SS burst set transmission operation in the base station according to the present disclosure;

FIG. 13 is a diagram illustrating a combination of the method-5-1 and the method 2-10-1 as another embodiment for obtaining the slot start point, the SS burst set start point, the half-frame timing index, and the system frame number in the terminal according to the present disclosure;

FIG. 14 is a diagram showing the SS burst set receiving operation and a base station operation for an initial cell selection terminal and an RRC_CONNECTED state terminal according to an embodiment of the present disclosure;

FIG. 15 is a diagram illustrating Alt 4 among the SS burst set receiving operation and the base station operation in neighbor cell PBCH decoding before the RRC-CONNECTED state terminal performs HO according to an embodiment of the present disclosure;

FIG. 16 is a diagram illustrating Alt 5 among the SS burst set receiving operation and the base station operation in neighbor cell PBCH decoding before the RRC-CONNECTED state terminal performs HO according to an embodiment of the present disclosure;

FIG. 17 is a diagram illustrating an example of intra-slot SS block mapping according to data subcarrier spacing (Data SCS) according to an embodiment of the present disclosure;

FIG. 18 illustrates a configuration diagram of an SS block according to an embodiment of the present disclosure;

FIG. 19 illustrates a configuration diagram of an SS block according to another embodiment of the present disclosure;

FIG. 20 illustrates a functional block diagram of a base station apparatus according to the present disclosure;

FIG. 21 illustrates a functional block diagram of a terminal apparatus according to the present disclosure;

FIG. 22 is a diagram illustrating a logical structure for signaling an SS block index according to the present disclosure; and

FIG. 23 is a diagram showing an inter-cell synchronization level according to an embodiment of the present disclosure.

### DETAILED DESCRIPTION

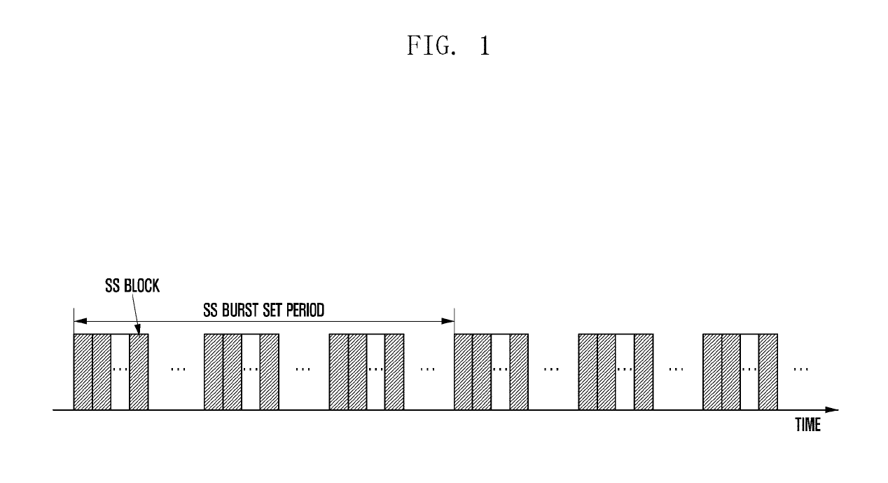

FIGS. 1 through 23, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the present disclosure will be described in detail with reference to the accompanying drawings. When it is decided that a detailed description for the known function or configuration related to the present disclosure may obscure the gist of the present disclosure, the detailed description therefor will be omitted. Further, the following terminologies are defined in consideration of the functions in the present disclosure and may be construed in different ways by the intention or practice of users and operators. Therefore, the definitions thereof should be construed based on the contents throughout the specification.

Various advantages and features of the present disclosure and methods accomplishing the same will become apparent from the following detailed description of embodiments with reference to the accompanying drawings. However, the present disclosure is not limited to the embodiments disclosed herein but will be implemented in various forms. The embodiments have made disclosure of the present disclosure complete and are provided so that those skilled in the art can easily understand the scope of the present disclosure. Therefore, the present disclosure will be defined by the scope of the appended claims. Like reference numerals throughout the description denote like elements.

In a wireless communication system, downlink (DL) common control signals include at least one of sync signals (SS), channel (or channels) on which system information (master information block (MIB), RMSI: remaining system information) necessary to perform at least random access is transmitted, a signal used for RRM measurement, and a signal used for L3 mobility. As the RRM measurement, beam measurement may be used. The DL common control signals should be broadcast so that users in a cell or neighboring cells can hear the DL common control signals. Therefore, in a multi-beam based system, the DL common control signals should be transmitted through multi-beam sweeping. Alternatively, the DL common control signals may be broadcast through multi-beam sweeping, but can be iteratively transmitted through a single beam.

A synchronization signal block (SS block, hereinafter, referred to as ‘SS block’) may include at least one of primary and secondary synchronization signals (P_{SS}, SSS) and a PBCH for the terminal. The PBCH is a channel used to transmit the MIB, and the RMSI (definition: minimum SI except for the MIB. The Minimum SI refers to minimum information required for the terminal to perform an initial access) may be transmitted on a channel separate from the PBCH. If the RMSI is transmitted on a separate channel from the PBCH, the RMSI is transmitted through the PDSCH. In addition, the SS block may include a third (tertiary) synchronization signal (TSS), a reference signal (RS) for PBCH decoding, and the like. Alternatively, the TSS may serve as a reference signal for PBCH decoding.

As described above, in the multi-beam-based system, in order for all terminals in a service area of the cell to receive the SS block at the time of transmitting the SS block, the base station should transmit the SS block using the beam sweep method. In this case, the SS blocks transmitted while one-time beam sweeping is completed are collectively referred to as an SS burst set. Alternatively, the SS block can be transmitted by a scheme of iteratively transmitting multiple SS blocks within the SS burst set through the single beam, not through the multi-beam sweeping. In this way, if the terminal receives one SS burst set when the base station iteratively transmits multiple SS blocks within the SS burst set, the terminal may receive at least one SS block within the SS burst set.

FIG. 1 is a diagram illustrating a transmission of an SS block and an SS burst set.

Referring to FIG. 1, the SS block may occupy a part or all of slots, and the SS blocks within the SS burst set may be mapped to a continuous OFDM symbol or may be mapped to a discontinuous OFDM symbol. One SS burst set may be subdivided into multiple SS bursts. That is, the SS burst may refer to a collection of the consecutive SS blocks. The SS blocks in the SS burst may be mapped to the continuous OFDM symbols or may be mapped to the discontinuous OFDM symbols. For example, if the total number of SS blocks configuring the SS burst set is 64 and the number of SS bursts is 16, one SS burst is a unit formed by collecting four continuous SS blocks (which does not mean that they are mapped to continuous OFDM symbols) within the SS burst set.

The terminal may differently recognize the transmission period of the SS burst set according to a state (i.e., initial access state, CONNECTED state, IDLE state) and an operating frequency. For example, the terminal which is operated in a frequency band A and performs an initial access may recognize a transmission period of the SS burst set as 10 ms or 20 ms. Alternatively, the terminal which is operated in a frequency band B and performs an initial access may recognize the transmission period of the SS burst set as 10 ms or 20 ms.

In addition, for the CONNECTED state terminal, the base station may configure the SS burst set period different from the period which the initial access terminal recognizes. Thereafter, the terminal may receive the SS burst set according to the SS burst set period that the base station configures. As the SS burst set period values that the base station may configure, 5, 10, 20, 40, 80, 160 ms, and the like may be used.

In addition, the IDLE terminal may use the configured SS burst set period as it is when being connected to the network as needed, or may receive the SS burst set based on the same SS burst set period as an initial access user.

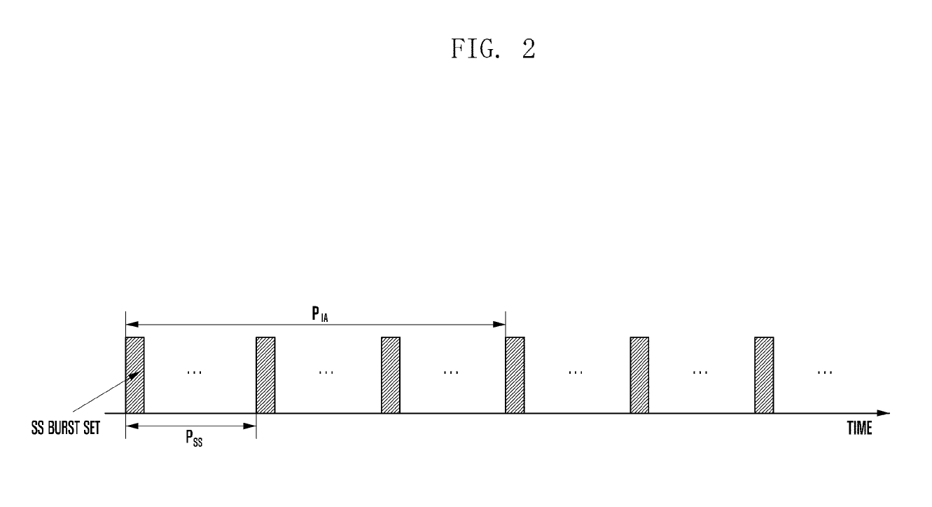

FIGS. 2 to 4 are diagrams showing the transmission methods of SS burst sets for various cases according to the state of the terminal and the configuration of the base station.

In FIGS. 2 to 4, the P_{IA} represents an initial access terminal-based SS burst set period and the P_{SS} represents a base station setting SS burst set period (for CONNECTED and/or IDLE users).

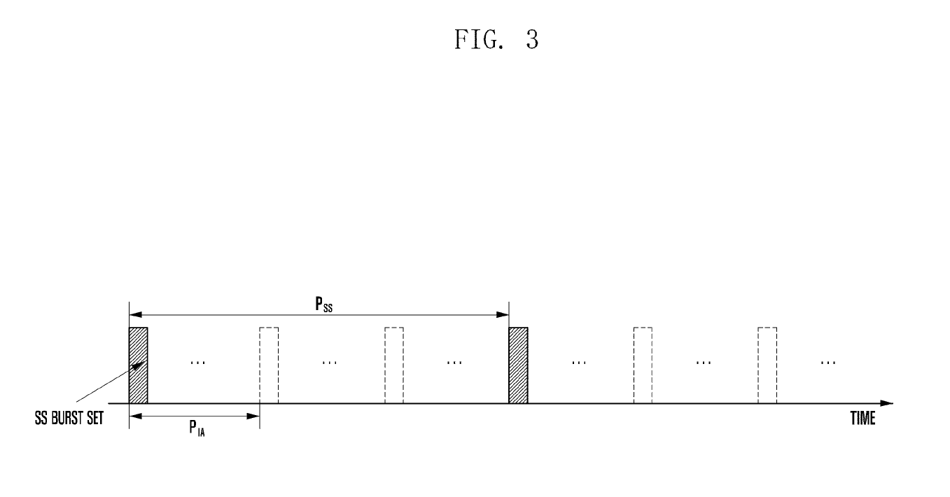

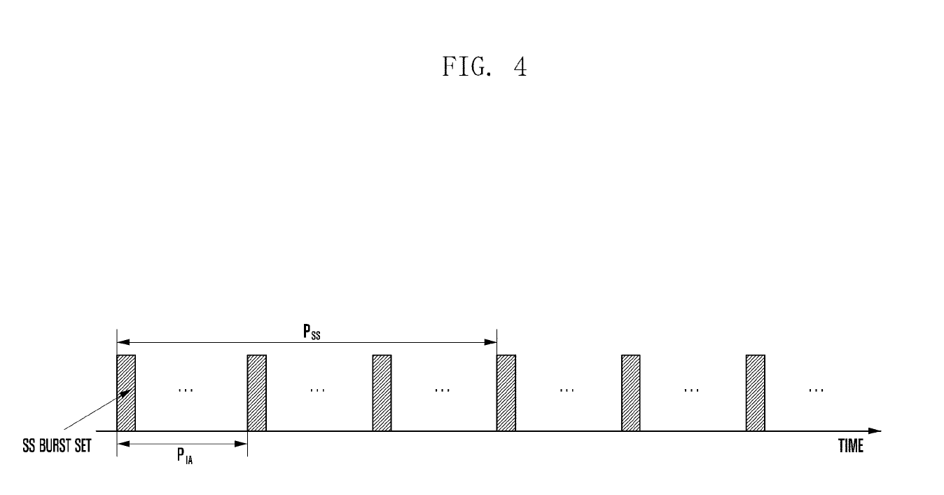

FIG. 2 shows a case where the P_{IA}, which is the initial access terminal-based SS burst set period, has a longer period than the P_{SS}. FIGS. 3 and 4 show the case in which the P_{SS} has a longer period than the P_{IA}. In addition, comparing between FIGS. 3 and 4, there may be a synchronization transmission time point during which a synchronization signal is not transmitted in at least one interval of the P_{IA} period within the P_{SS} period.

The terminal should be able to acquire the time/frequency synchronization, the system frame number, the SS burst set start point, the half-frame timing index information or the like through the SS burst set reception or the additional channel reception other than the SS burst set reception. As described above, the SS block transmitted within the SS burst set may include P_{SS}, SSS, PBCH, TSS (or DMRS for PBCH decoding), and the like. The reason why the SS burst set start point and the half-frame timing index information needs to be acquired is as follows.

In the multi-beam based system, if the number of SS blocks in a set of SS bursts is large, a set of SS bursts may be transmitted over multiple slots in one radio frame. Also, as the plurality of SS burst sets in one radio frame may be transmitted, the terminal needs to know information on whether the SS block received by the terminal is transmitted in an n-th OFDM symbol of an n-th SS burst set, so that it is possible to know the accurate start point of the subsequent frame. The SS burst set start point information may also be thought of as a half-radio frame timing index information acquisition. As the SS burst set period may be 5 ms, two sets of SS bursts in the radio frame defined as 10 ms may be located. As a result, knowing the SS burst start point is to clearly know the positional information corresponding to 0 ms or 5 ms within a radio frame of 10 ms, not the accurate start point of the frame. This may be known by the SS block index information within the SS burst set or combining the SS block index within the SS burst set with the SS burst index within the SS burst set. That is, the position of the SS burst set start point may be inferred by combining the SS block index information in the SS burst acquired by the terminal with the SS burst index information within the SS burst set. As described above, only the location information corresponding to 0 ms or 5 ms in the radio frame of 10 ms is known only by the start point position of the SS burst set. Therefore, in order for the terminal to clearly know the half-frame timing index, a process of founding out whether the received SS burst set is an SS burst set starting from 0 ms or an SS burst set starting from 5 ms is used, which may be interpreted as a process of founding out a half-radio frame timing. In the present disclosure, the process of knowing the half-radio frame timing is indicated as a process of finding the half-frame timing index.

Hereinafter, the method for acquiring the SS burst set start point information, the half-frame timing index information, and the system frame number through the reception of the SS block and the RMSI transmission channel (PDSCH) will be roughly divided into three methods.

### <Method 1>

Method 1 may obtain the information on the start point of the terminal reception SS burst set. Specifically, one or more signal/channel of the SSS, TSS, RMSI, and PBCH may be utilized, and the method may be divided into the following methods.

Method 1-1: It is possible to acquire the SS burst set start point information through the TSS.

Method 1-2: It is possible to acquire the SS burst set start point information through the TSS and the RMSI.

Method 1-3: It is possible to acquire the SS burst set start point information through the SSS and the TSS.

Method 1-4: It is possible to acquire the SS burst set start point information on the PBCH.

Method 1-4-1: It is possible to acquire the SS burst set start point information by the information in the MIB and the PBCH blind decoding.

Method 1-4-2: It is possible to acquire the SS burst set start point information through the PBCH blind decoding.

Method 1-4-3: It is possible to acquire the SS burst set start point information through the information in the MIB.

Method 1-5: It is possible to acquire the SS burst set start point information through the TSS and the PBCH.

Method 1-5-1: It is possible to acquire the information in the MIB and the SS burst set start point information through the TSS.

Method 1-5-2: It is possible to acquire the SS burst set start point information through the PBCH blind decoding and the TSS.

Method 1-6: It is possible to acquire the SS burst set start point information through the SSS and the PBCH.

Method 1-6-1: It is possible to acquire the information in the MIB and the SS burst set start point information through the SSS.

Method 1-6-2: It is possible to acquire the SS burst set start point information through the PBCH blind decoding and the SSS.

### <Method 2>

Method 2 may be roughly divided into a method for acquiring the half-frame timing index and the system frame number information. Hereinafter, they will be divided into method 2-1, method 2-2, method 2-3, and method 2-4, respectively.

Method 2-1: It is possible to acquire the half-frame timing index and the LSB information through the MSB information in the MIB and the PBCH blind decoding by the method for acquiring the half-frame timing index and the system frame number information on the PBCH. Specifically describing, the Method 2-1 may be sub-divided into the following two methods as follows.

Method 2-1-1: It is possible to perform the half-frame timing index and LSB transmission, the MSB transmission in the MIB using the scrambling sequence, MSB transmission in MIB.

Method 2-1-2: It is possible to perform the half-frame timing index and LSB transmission in which a CRC cyclic shift is applied to a redundancy version (RV) and the MSB transmission in the MIB.

Method 2-2: It is possible to acquire the half-frame timing index and system frame number information on the PBCH and the TSS. Specifically, the MSB information in the MIB, the LSB information acquisition through the PBCH blind decoding, and the half-frame timing index information through the TSS reception may be obtained.

Scheme 2-3: It is possible to acquire the half-frame timing index and system frame number information on the PBCH and the RMSI or the PBCH, the TSS, and the RMSI. Specifically, it is possible to acquire the LSB information and the half-frame timing index information by the scheme of acquiring the MSB information in the LSB information and the frame start point information according to the above-described Schemes 2-1/2-2.

Method 2-4: It is possible to acquire the half-frame timing index and system frame number information on the PBCH and the SSS. Specifically, the MSB information in the MIB, the LSB information acquisition through the PBCH blind decoding, and the half-frame timing index information through the SSS reception may be obtained.

Method 2-5: It is possible to acquire the half-frame timing index and system frame number information on the PBCH and the TSS. Specifically, it is possible to acquire the total system frame number in the MIB and the half-frame timing index information through the TSS.

Method 2-6: It is possible to acquire the half-frame timing index and system frame number information on the PBCH and the SSS. Specifically, it is possible to acquire the total system frame number in the MIB and the half-frame timing index information through the SSS.

Method 2-7: It is possible to acquire the half-frame timing index and system frame number information on the PBCH. Specifically, it is possible to acquire the total system frame number in the MIB and the half-frame timing index information through the PBCH blind decoding.

Method 2-8: The method for acquiring the half-frame timing index and system frame number information on the PBCH and the TSS may be used. Specifically, it is possible to acquire the MSB in the MIB and the half-frame timing index information and acquire the LSB information through the TSS.

Method 2-9: The method for acquiring the half-frame timing index and system frame number information on the PBCH and the SSS may be used. Specifically, it is possible to acquire the MSB in the MIB and the half-frame timing index information and acquire the LSB information through the SSS.

Method 2-10: The method for acquiring the half-frame timing index and system frame number information on the PBCH may be used. Specifically, it is possible to acquire the MSB in the MIB and the half-frame timing index information and the LSB information through the PBCH blind decoding.

Method 2-11: The method for acquiring the half-frame timing index and system frame number information on the PBCH may be used. Specifically, it is possible to acquire the MSB in the MIB, the LSB, and the half-frame timing index information.

### <Method 3>

In Method 3, it is possible to acquire the SS burst set start point/frame start point/system frame number information on the PBCH The method 3 may be sub-divided into the following methods again.

Method 3-1: It is possible to perform the MSB transmission in the MIB and the SS burst set start point/half-frame timing index and LSB transmission using the scrambling sequence.

Method 3-2: It is possible to perform the MSB transmission in the MIB and the SS burst set start point/half-frame timing index and LSB transmission in which the CRC cyclic shift is applied to the redundancy version (RV).

Method 3-3: Including the MSB transmission in the MIB, some of the information for knowing the SS burst set start point in the MIB, including some of the information for knowing the SS burst set start point using the scrambling sequence/half-frame timing index information and LSB transmission.

Method 3-4: Including the MSB transmission in the MIB, some of the information for knowing the SS burst set start point in the MIB, including some of the information for knowing the SS burst set start point/half-frame timing index information and LSB transmission in which the CRC cyclic shift is applied to the redundancy version (RV).

In order for the terminal to known inform the terminal of the SS burst set start point (half-radio half-frame timing index), the half-frame timing index information (half-radio frame timing), and the system frame numbers (MSB and LSB) as described above, the base station may transmit the corresponding information by combining one of the methods 1 with one of the methods 2 or transmit the corresponding information by one of the methods 3. The bits configuring the system frame number are divided into the MSB and the LSB, and the MSB is basically included as the contents of the MIB or the RMSI. There are various ways for transmitting the LSB. The terminal may know the total system frame number by the method for acquiring various MSB/LSB proposed in the present disclosure. The present disclosure discloses a system in which the system frame number is represented by a total of 10 bits. When the PBCH TTI is 80 ms, to allow the LSB of the system frame number to represent (=80 ms/10 ms) 3 hypotheses, the case of transmitting information corresponding to 3 bits is considered to represent 8 hypotheses. Therefore, as the system frame number is 10 bits and the LSB is 3 bits, the case in which the MSB is 7 bits is considered. When the PBCH TTI is 80 ms, the number of bits transmitted by the MSB may be changed depending on the total number of bits transmitted by the system frame number. In the present disclosure, N hypotheses represent a guessing frequency that the terminal should try to find out specific information. That is, the base station carries the promised information between the base station and the terminal on the specific channel/signal so that the terminal may find out information through the N hypothesis. For example, when the terminal needs to distinguish 4 hypotheses through the SSS to find out the specific information, the base station may indicate the specific information using one of the promised 4 sequences between the base station and the terminal to transmit the specific value, and the terminal may basically find out one value that the base station transmits through correlation for four sequences to find out what information is transmitted through the SSS. As another example, when the terminal has to distinguish 8 hypotheses applied to PBCH bits to find out the specific information, the base station may transmit the specific value using one of 8 kinds of scrambling sequences promised between the base station and the terminal to indicate the specific information, and the terminal may decode a signal on the assumption that the 8 scrambling sequences are basically applied to find out what information is transmitted through the scrambling sequence applied to the PBCH bits and find out one value which the base station transmits when the decoding succeeds.

A detailed embodiment of each method will be described below. For the following description, regardless of the P_{SS} or P_{IA} value, an actual period a value corresponding to P_{SS} P_{SS}/P_{IA} in the actual period in which the base station transmits the SS burst set, for example, values corresponding to P_{SS}/P_{SS}/P_{IA} in the case of FIGS. 2 to 4 are referred to as P_{Actual}. If the system is not permitted the case shown in FIG. 4, the P_{Actual} may be automatically interpreted as the P_{SS}.

<Method 1-1. Acquisition of SS Burst Set Start Point Information Through TSS>

It is assumed that a unit of an SS slot is defined (e.g., SS subcarrier spacing (SS SCS)=60 kHz, 14 OFDM symbols are included in the SS slot, a total length of the SS slot is 0.25 ms), and Nos. 3 to 10 OFDM symbols in one slot are used for the SS block transmission, and two OFDM symbols in the SS slot are used to transmit one SS block.

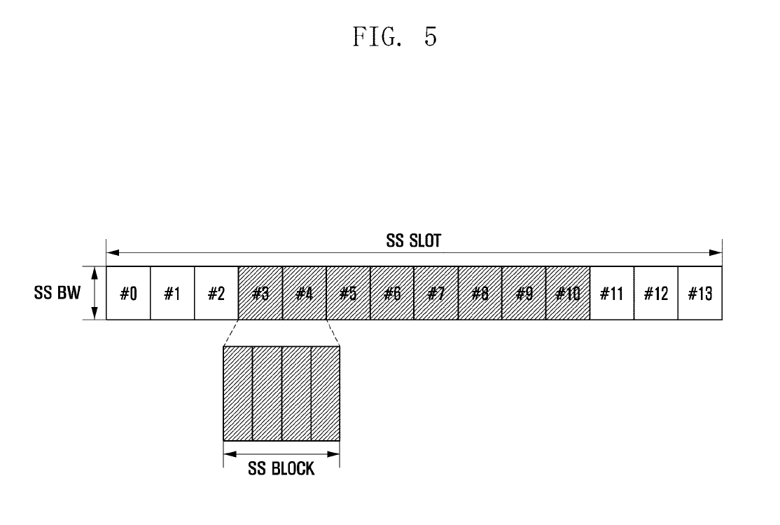

This will be described with reference to FIG. 5. FIG. 5 is a diagram illustrating the transmission of the SS slot and the SS block.

At this time, the SS burst set may transmit the SS block over the plurality of SS slots. The SS slot is designed as shown in FIG. 5; when the number of maximum available SS blocks is 16; when a sequence of length L (i.e., d(0), . . . , d (L−1)) is used as the base sequence for the TSS; the TSS sequence transmitted in an m-th block may be represented by the following <Equation 1>.

d^{m}(n)=d((n+m)mod L,n=0, . . . ,L−1 [Equation 1]

The terminal may compare d^{m} with d and distinguish whether the TSS received by the terminal is the TSS in an n-th SS block set within the SS burst set. If the TSS is TSS received in a second SS block within the SS burst set (m=2), the terminal may sense that the TSS in the SS block transmitted at #5 to #6 of a first SS slot of the SS slots in which the SS burst is transmitted, and it may be found that the time point at which the first OFDM (#0) of the corresponding slot is transmitted is the start point (half-half-frame timing index) of the SS burst set.

In addition to a function of indicating an n-th SS block within the SS burst set through the TSS, a function of indicating the total number of SS slots in which the SS burst set is transmitted (i.e., indicating the number of actually transmitted SS blocks) may be added. In one embodiment, when a sequence (i.e., d (0), . . . , d (L−1)) of length L is used as the base sequence for the TSS; when the number of SS slots in which the SS burst set is transmitted can be 1, 2, or 4; the TSS sequence transmitted in the m-th block may be represented by the following <Equation 2>.

d^{m}(n)=d((n+Δₘ)mod L),n=0, . . . ,L−1 [Equation 2]

In addition, an example of the cyclic shift index (Δₘ) of the TSS is shown in the following Table 1.

TABLE 1

| The number of SS slots used | SS block number | |
|---|---|---|
| for SS burst set transmission | in SS burst set | Cyclic shift index (Δₘ) |
| 1 | 0, 1, 2, 3 | 0, . . . , 3 |
| 2 | 0, 1, . . . , 6, 7 | 4, . . . , 11 |
| 4 | 0, 1, . . . , 10, 11 | 12, . . . , 23 |

As another embodiment, in addition to the function of indicating whether the TSS is the TSS in the n-th SS block within the SS burst set and the function of indicating the total number of SS slots in which the SS burst set is transmitted, the base station may add a function of indicating whether it is a single beam or multi-beam based system. In this case, the TSS sequence transmitted in the m-th block may be represented by the following Equation 2, and the cyclic shift index (Δₘ) of the TSS may be represented as shown in the following Table 2.

TABLE 2

| The number of SS | | | |
|---|---|---|---|
| slots used for SS | The number of | | Cyclic |
| burst set | blocks in SS burst | SS block number in | shift index |
| transmission | set = 1? | SS burst set | (Δₘ) |
| 1 | Yes | 0 | 0 |
| | No | 0, 1, 2, 3 | 1, . . . , 4 |
| 2 | No | 0, 1, . . . , 6, 7 | 5, . . . , 12 |
| 4 | No | 0, 1, . . . , 10, 11 | 13, . . . , 24 |

That is, the above Table 1 shows the cyclic shift index (Δₘ) of the tertiary synchronization signals (TSS) when informing the number of SS blocks within the SS burst set and the total number of SS slots in which the SS burst set is transmitted, and the above <Table 2> shows the cyclic shift index (Δₘ) of the TSS when informing the number of SS blocks within the SS burst set, the total number of SS slots in which the SS burst set is transmitted, and the single/multi-beam based system.

As described in the above embodiment, the information to be transmitted may be transmitted through the TSS with different cyclic shifts, but any method for indicating a hypothesis by the number of SS blocks within the SS burst set through the TSS can be used. For example, the information on the SS burst set start point may also be transmitted by using cyclic shifts and different root indexes.

The TSS may be the sequence form as described in the above embodiment, but may transmit the corresponding information in a message form.

<Method 1-2. Acquisition of SS Burst Set Start Point Information Through TSS and RMSI>

It is possible for the terminal to clearly recognize the SS burst set start point by using the TSS and the RMSI together. For example, in the system shown in FIG. 5, a method for transmitting the SS block number information in the SS slot (SS slot start point acquisition) through the TSS and indicating the remaining information (accurate SS burst set start point, i.e., slot number within the SS burst set) through the RMSI is possible. The terminal may decode the RMSI at the corresponding location after finding the approximate location (transmittable time window) at which the RMSI is transmitted through the MIB in the SS block (or receiving the DCI scheduled through the MIB). For example, the terminal finds that the RMSI is transmitted every 20 ms through the reception of the MIB. In the standard, the RMSI is specified to be able to be transmitted from SS slot No. 16 in the frame including the RMSI, and if the SS slot in which the MIB can be received is SS slot Nos. 0 to 3 in the frame and the frame in which the MIB is received is the frame including the RMSI, the terminal may find the RMSI through the blind decoding from the time point (based on the time point at which the first MIB is received if the MIB is received through the plurality of SS blocks) to slots after 13 slots to slots after 16 slots. Then, it is possible to accurately acquire the SS burst set start point information through the slot number in the RMSI.

As another method, a method for indicating the SS burst start point (SS block in the SS burst) through the TSS and the remaining information through the RMSI is possible. For example, in a system in which the number of SS blocks in an SS burst set is 64 and in the system in which 4 SS blocks may be transmitted in one slot as shown in FIG. 5, when the SS burst is referred to as a collection of the SS blocks transmitted over 4 slots, the TSS should have a function of distinguishing between 16 hypotheses, and the RMSI should have a function of distinguishing 4 hypotheses.

As another method, a method for indicating the SS burst start point (SS block in the SS burst) through the RMSI and the remaining information through the TSS is possible. For example, in a system in which the number of SS blocks in an SS burst set is 64 and in the system in which 4 SS blocks may be transmitted in one slot as shown in FIG. 5, when the SS burst is referred to as a collection of the SS blocks transmitted over 4 slots, the RMSI should have the function of distinguishing between 16 hypotheses, and the TSS should have the function of distinguishing 4 hypotheses.

<Method 1-3. Acquisition of SS Burst Set Start Point Information Through SSS and TSS>

It is possible to transmit the slot start point information through the TSS and the SS burst set start point (half-half-frame timing index) information through the SSS. For example, in the system shown in FIG. 5, a method for transmitting the SS block number information in the SS slot (the sequence/message based method as described in the method-1 is possible) through the TSS and indicating the remaining information (correct SS burst set start point) through the SSS is possible. For example, in a system in which the number of SS blocks in an SS burst set is 64 and 4 SS blocks can be transmitted in one slot as shown in FIG. 5, the TSS should have a function of distinguishing 4 hypotheses (e.g., the cyclic shift version can be used based on one sequence as described in the method-1), and the SSS should have a function to distinguish 16 hypotheses.

As another method, a method for indicating the SS burst start point (SS block index in the SS burst) instead of the slot start point through the TSS and transmitting the SS burst set start point (SS burst index within the SS burst set) information through the SSS is possible. In this case, a method for transmitting the SS block number information in the SS slot (the sequence/message based method as described in the method-1 is possible) through the TSS and indicating the remaining information (correct SS burst set start point) through the SSS is possible. For example, in a system in which the number of SS blocks in an SS burst set is 64 and in the system in which 4 SS blocks may be transmitted in one slot as shown in FIG. 5, when the SS burst is referred to as a collection of the SS blocks transmitted over 4 slots, the TSS should have a function of distinguishing between 16 hypotheses, and the SSS should have a function of distinguishing 4 hypotheses. As another method, a method for transmitting the slot start point information through the SSS and transmitting the SS burst set start point information through the TSS is also possible. For example, in the system shown in FIG. 5, a method for transmitting the SS block number in the SS block through the SSS and indicating the remaining information (accurate SS burst set start point) through the TSS is possible. For example, in a system in which the number of SS blocks in an SS burst set is 64 and 4 SS blocks can be transmitted in one slot as shown in FIG. 5, the SSS should have a function of distinguishing 4 hypotheses (e.g., the cyclic shift version can be used based on one sequence as described in the method-1), and the TSS should have a function to distinguish 16 hypotheses.

As another method, a method for indicating the SS burst start point (SS block index in the SS burst) instead of the slot start point through the SSS and transmitting the SS burst set start point (SS burst index within the SS burst set) information through the TSS is possible. In this case, a method for transmitting SS block number information in the SS burst through the SSS and indicating the remaining information (accurate SS burst set start point, i.e., SS burst number within the SS burst set) through the TSS is possible. For example, in a system in which the number of SS blocks in an SS burst set is 64 and in the system in which 4 SS blocks may be transmitted in one slot as shown in FIG. 5, when the SS burst is referred to as a collection of the SS blocks transmitted over 4 slots, the SSS should have the function of distinguishing between 16 hypotheses, and the TSS should have the function of distinguishing 4 hypotheses.

<Method 1-4-1. Acquisition of SS Burst Set Start Point Information Through PBCH: Acquisition of Information in MIB and SS Burst Set Start Point Information Through PBCH Blind Decoding>

It is possible to acquire the SS burst set start point information on the PBCH. In particular, it is possible to indicate the SS burst index within the SS burst set (explicit scheme) through the MIB and indicate the SS block index in the SS burst (implicit scheme) through the PBCH blind decoding. For example, in a system in which the number of SS blocks in an SS burst set is 64 and 4 SS blocks can be transmitted in one slot as shown in FIG. 5, when the SS burst refers to a collection of the SS blocks transmitted over 4 slots, the base station should transmit the PBCH using 16 hypothesis (e.g., scrambling code) promised between the base station and the terminal, and the terminal should be able to find the SS block index information in the SS burst by performing the blind decoding and the MIB provides the SS burst index information within the SS burst set to a payload through 2 bits. The change in the bit (explicit bit) in the MIB transmitted for each SS burst does not mean that the terminal may not be able to combine the plurality of SS blocks within the SS burst set at the time of the PBCH decoding or to combine the plurality of SS blocks in multiple SS burst sets. However, the blind decoding may be accompanied at the time of combining the plurality of SS block to find the SS burst index information within the SS burst set in the MIB.

As another method, it is possible to indicate the SS block index in the SS burst through the MIB (explicit scheme) and indicate the SS burst index within the SS burst set through the PBCH blind decoding (implicit scheme). For example, in a system in which the number of SS blocks in an SS burst set is 64 and 4 SS blocks can be transmitted in one slot as shown in FIG. 5, when the SS burst refers to a collection of the SS blocks transmitted over 4 slots, the base station should transmit the PBCH using 4 hypothesis (e.g., scrambling code) promised between the base station and the terminal, and the terminal should be able to find the SS burst index information in the SS burst by performing the blind decoding and the MIB provides the SS block index information in the 4-bit SS burst set to a payload. The change in the bit (explicit bit) in the MIB transmitted for each SS block in each SS burst does not mean that the terminal may not be able to combine the plurality of SS blocks within the SS burst set at the time of the PBCH decoding or combine the plurality of SS blocks in multiple SS burst sets. However, the blind decoding may be accompanied at the time of combining the plurality of SS block to find the SS block index information in the SS burst in the MIB.

<Method 1-4-2. Acquisition of SS Burst Set Start Point Information Through PBCH: Acquisition of SS Burst Set Start Point Information Through PBCH Blind Decoding>

It is possible to acquire the SS burst set start point information on the PBCH, in particular it is possible to inform the SS block index within the SS burst set through the PBCH blind decoding (implicit scheme). For example, in a system in which the number of SS blocks within the SS burst set 64, the base station transmits the PBCH using 64 hypothesis (e.g., scrambling code) promised between the base station and the terminal, and the terminal should be able to find the SS block index information within the SS burst set by performing the blind decoding. For example, the base station multiplies the PBCH information bits transmitted from each of the 64 SS blocks within the SS burst set by 64 different scrambling sequences promised between the base station and the terminal and transmits it, and the terminal may infer the SS block index information within the SS burst set by testing whether the PBCH succeeds when descrambling is performed with any of 64 scrambling sequences.

<Method 1-4-3. Acquisition of SS Burst Set Start Point Information Through Information in MIB>

It is possible to acquire the SS burst set start point information on the PBCH, in particular it is possible to inform the SS block index within the SS burst set. For example, the MIB in the PBCH included in the SS block within the SS burst set may include the SS block index within the SS burst set. The change in the bit (explicit bit) in the MIB transmitted for each SS block in each SS burst set does not mean that the terminal may not be able to combine the plurality of SS blocks within the SS burst set at the time of the PBCH decoding or combine the plurality of SS blocks in multiple SS burst sets. However, the blind decoding may be accompanied at the time of combining the plurality of SS block to find the SS block index information within the SS burst set in the MIB.

<Method 1-5-1. Acquisition of SS Burst Set Start Point Information Through TSS and PBCH: Acquisition of Information in MIB and SS Burst Set Start Point Information Through TSS>

It is possible to acquire the SS burst set start point information through the TSS and the PBCH. In particular, it is possible to indicate the SS burst index within the SS burst set (explicit scheme) through the MIB and indicate the SS block index in the SS burst through the TSS. For example, in a system in which the number of SS blocks in an SS burst set is 64 and 4 SS blocks can be transmitted in one slot as shown in FIG. 5, when the SS burst refers to a collection of the SS blocks transmitted over 4 slots, the TSS should be able to indicate 16 hypothesis so that the terminal may obtain the SS block index information, and the MIB provides the SS burst index information within the SS burst set to a payload through 2 bits. The change in the bit (explicit bit) in the MIB transmitted for each SS burst does not mean that the terminal may not be able to combine the plurality of SS blocks within the SS burst set at the time of the PBCH decoding or combine the plurality of SS blocks in multiple SS burst sets. However, the blind decoding may be accompanied at the time of combining the plurality of SS blocks to find the SS block index information in the SS burst in the MIB.

As another method, it is possible to indicate the SS block index in the SS burst through the MIB (explicit scheme) and indicate the SS burst index within the SS burst set through the TSS. For example, in a system in which the number of SS blocks in an SS burst set is 64 and 4 SS blocks can be transmitted in one slot as shown in FIG. 5, when the SS burst refers to a collection of the SS blocks transmitted over 4 slots, the TSS should be able to indicate 4 hypothesis so that the terminal may obtain the SS block index information within the SS burst set, and the MIB provides the SS burst index information within the SS burst set to a payload through 4 bits. The change in the bit (explicit bit) in the MIB transmitted for each SS block in each SS burst does not mean that the terminal may not be able to combine the plurality of SS blocks within the SS burst set at the time of the PBCH decoding or combine the plurality of SS blocks in multiple SS burst sets. However, the blind decoding may be accompanied at the time of combining the plurality of SS block to find the SS block index information in the SS burst in the MIB.

<Method 1-5-2. Acquisition of SS Burst Set Start Point Information Through TSS and PBCH: Acquisition of Information in MIB and SS Burst Set Start Point Information Through PBCH Blind Decoding and TSS>

It is possible to acquire the SS burst set start point information through the TSS and the PBCH. In particular, it is possible to indicate the SS burst index in the SS burst through the PBCH blind decoding (implicit scheme) and indicate the SS block index within the SS burst set through the TSS. For example, in a system in which the number of SS blocks in an SS burst set is 64 and 4 SS blocks can be transmitted in one slot as shown in FIG. 5, when the SS burst refers to a collection of the SS blocks transmitted over 4 slots, the base station should transmit the PBCH using 16 hypothesis (e.g., scrambling code) promised between the base station and the terminal, and the terminal should be able to find the SS block index information in the SS burst by performing the blind decoding, and the TSS should be able to indicate 4 hypotheses so that the terminal may find the SS burst index information within the SS burst set.

As another method, it is possible to indicate the SS block index in the SS burst through the TSS and indicate the SS burst index within the SS burst set through the PBCH blind decoding (implicit scheme). For example, in a system in which the number of SS blocks in an SS burst set is 64 and 4 SS blocks can be transmitted in one slot as shown in FIG. 5, when the SS burst refers to a collection of the SS blocks transmitted over 4 slots, the base station should transmit the PBCH using 4 hypothesis (e.g., scrambling code) promised between the base station and the terminal, and the terminal should be able to find the SS burst index information in the SS burst by performing the blind decoding, and the TSS indicates that the terminal allows the SS burst MIB to provide the SS burst block index information in the 4-bit SS burst to a payload.

<Method 1-6-1. Acquisition of SS Burst Set Start Point Information Through SSS and PBCH: Acquisition of Information in MIB and SS Burst Set Start Point Information Through SSS>

It is possible to acquire the SS burst set start point information through the SSS and the TSS and the PBCH. In particular, it is possible to indicate the SS burst index within the SS burst set (explicit scheme) through the MIB and indicate the SS block index in the SS burst through the SSS. For example, in a system in which the number of SS blocks in an SS burst set is 64 and 4 SS blocks can be transmitted in one slot as shown in FIG. 5, when the SS burst refers to a collection of the SS blocks transmitted over 4 slots, the SSS should be able to indicate 16 hypothesis so that the terminal may obtain the SS block index information, and the MIB provides the SS burst index information within the SS burst set to a payload through 2 bits. The change in the bit (explicit bit) in the MIB transmitted for each SS burst does not mean that the terminal may not be able to combine the plurality of SS blocks within the SS burst set at the time of the PBCH decoding or combine the plurality of SS blocks in multiple SS burst sets. However, the blind decoding may be accompanied at the time of combining the plurality of SS blocks to find the SS block index information in the SS burst in the MIB.

As another method, it is possible to indicate the SS block index in the SS burst through the MIB (explicit scheme) and indicate the SS burst index within the SS burst set through the SSS. For example, in a system in which the number of SS blocks in an SS burst set is 64 and 4 SS blocks can be transmitted in one slot as shown in FIG. 5, when the SS burst refers to a collection of the SS blocks transmitted over 4 slots, the SSS should be able to indicate 4 hypothesis so that the terminal may obtain the SS block index information, and the MIB provides the SS burst index information in the SS burst to a payload through 2 bits. The change in the bit (explicit bit) in the MIB transmitted for each SS block in each SS burst does not mean that the terminal may not be able to combine the plurality of SS blocks within the SS burst set at the time of the PBCH decoding or combine the plurality of SS blocks in multiple SS burst sets. However, the blind decoding may be accompanied at the time of combining the plurality of SS block to find the SS block index information in the SS burst in the MIB.

<Method 1-6-2. Acquisition of SS Burst Set Start Point Information Through SSS and PBCH: Acquisition of Information in MIB and SS Burst Set Start Point Information Through PBCH Blind Decoding and SSS>

It is possible to acquire the SS burst set start point information through the SSS and the PBCH. In particular, it is possible to indicate the SS burst index in the SS burst through the PBCH blind decoding (implicit scheme) and indicate the SS block index within the SS burst set through the SSS. For example, in a system in which the number of SS blocks in an SS burst set is 64 and 4 SS blocks can be transmitted in one slot as shown in FIG. 5, when the SS burst refers to a collection of the SS blocks transmitted over 4 slots, the base station should transmit the PBCH using 16 hypothesis (e.g., scrambling code) promised between the base station and the terminal, and the terminal should be able to find the SS block index information in the SS burst by performing the blind decoding, and the SSS should be able to indicate 4 hypotheses so that the terminal may find the SS burst index information within the SS burst set.

As another method, it is possible to indicate the SS block index in the SS burst through the SSS and indicate the SS burst index within the SS burst set through the PBCH blind decoding (implicit scheme). For example, in a system in which the number of SS blocks in an SS burst set is 64 and 4 SS blocks can be transmitted in one slot as shown in FIG. 5, when the SS burst refers to a collection of the SS blocks transmitted over 4 slots, the base station should transmit the PBCH using 4 hypothesis (e.g., scrambling code) promised between the base station and the terminal, and the terminal should be able to find the SS burst index information in the SS burst by performing the blind decoding, and the SSS indicates that the terminal allows the SS burst MIB to provide the SS burst block index information in the 4-bit SS burst to a payload.

<Method 2-1-1. Acquisition of Half-Frame Timing Index and System Frame Number Information Through PBCH: Half-Frame Timing Index and LSB Transmission, MSB Transmission in MIB Using Scrambling Sequence>

In the present embodiment, a method of performing the PBCH blind decoding to obtain an accurate half-frame timing index and the LSB among the system frame numbers is proposed. In particular, the base station/terminal operation will be described when the base station uses various scrambling sequences to indicate the half-frame timing index and the LSB at the time of the blind decoding.

Even if the terminal finds the slot start point and the SS burst set start point through the methods 1-1, 1-2, 1-3, or the like, the half-frame timing index and the system frame number should be obtained to be able to obtain system time axis information. In particular, as the period of the SS burst set transmitted from the base station may be 5 ms, the terminal can not find a clear half-frame timing index only by finding the SS burst set start point. Therefore, there is a need for a method for finding the clear half-frame timing index.

In order for the terminal to acquire the half-frame timing index and the system frame number for all cases shown in FIGS. 2 to 4, the scrambling sequence applied at the time of transmitting the PBCHs for each base station may be represented as follows. The terminal can find the MSB of the system frame number in the MIB after the PBCH decoding on the half-frame timing index and the LSB of the system frame number through the blind decoding through the possible scrambling sequence at the time of the PBCH decoding, and infer the total system frame numbers by the combination of the MSB and the LSB.

<Method 2-1-1-1: Case in which PBCH TTI is not Fixed and P_{Actual} Information is not Transmitted Through TSS>

Since the minimum P_{SS} that may be transmitted by the base station may be smaller than the P_{IA}, the scrambling sequence applied at the time of PBCH transmission should be changed in units of the minimum allowable P_{SS} value (hereinafter, expressed by min (P_{SS})), and since the PBCH TTI is not fixed, the scrambling sequence should be reset based on the maximum allowable P_{SS} value (hereinafter, expressed by max (P_{SS})). That is, M_{bit}^{P}^{_{Actual}} information bit blocks b^{P}^{_{Actual}}(0), . . . , b^{P}^{_{Actual}}(M_{bit}^{P}^{_{Actual}}−1) to be transmitted on the PBCH are scrambled into \tilde{b}^{P}^{_{Actual}}(i)=(b^{P}^{_{Actual}}(i)+c^{P}^{_{Actual}}(i))mod 2 using a cell-specific sequence prior to modulation. M_{bit}^{P}^{_{Actual}} represents an information bit block size depending on the P_{Actual} value, and is represented by the following Equation 3.

M_{bit}^{P}^{_{Actual}}=L_{bit}·(max(P_{SS})/(P_{Actual})·N [Equation 3]

L_{bit} represents the payload size including the CRC of the PBCH, and N represents the minimum number of times of combining for robust reception of the PBCH of the terminal.

c is a sequence of L_{bit}·(max(P_{SS})/min(P_{SS}))·N length.

(n_{f}·T_{frame})mod(max(P_{SS})·N=0 [Equation 4]

In the above Equation (4), T_{frame} is 10 ms.

b is an information bit block having a length of L_{bit}·(max(P_{SS})/min(P_{SS}))·N. c^{P}^{_{Actual}} represents a scrambling sequence applied to the PBCH information bit block depending on the P_{Actual} value, and has the same value as a part or all of c. When the scrambling sequence c is represented by multiple sequences cⱼ having a length of L_{bit}, this may be represented by the following Equation 5.

$$c = [ {c}_{0} , {c}_{1} , … , {c}_{( \frac{max ( {P}_{SS} ) \cdot N}{min ( {P}_{SS} )} )} ] \qquad [ Equation 5 ]$$

In the above Equation 5, each cⱼ is involved in the scrambling of the information bit block transmitted in one SS burst set. c^{P}^{_{Actual}} is configured of an ordered list of cⱼ satisfying the following Equation 6.

j mod(P_{Actual}/min(P_{SS}))=0 [Equation 6]

For example, if P_{Actual}=10 ms and min (P_{SS})=5 ms, then

$${c}^{{P}_{Actual}} = [ {c}_{0} , {c}_{1} , … , {c}_{( \frac{max ( {P}_{SS} ) \cdot N}{min ( {P}_{SS} )} )} ] ( if \frac{max ( {P}_{SS} ) \cdot N}{min ( {P}_{SS} )} is even ) .$$

b^{P}^{_{Actual}} represents the information bit block depending on the P_{Actual} value, and has the same value as a part or all of b. If the information bit block b is represented by a plurality of blocks bⱼ having a length of L_{bit}, then

$$b = [ {b}_{0} , {b}_{1} , … , {b}_{( \frac{max ( {P}_{SS} ) \cdot N}{min ( {P}_{SS} )} )} ] .$$

b^{P}^{_{Actual}} is configured of an ordered list of bⱼ satisfying j mod(P_{Actual}/min(P_{SS}))=0. For example, if P_{Actual}=10 ms and min (P_{SS})=5 ms, then

$${b}^{{P}_{Actual}} = [ {b}_{0} , {b}_{1} , … , {b}_{( \frac{max ( {P}_{SS} ) \cdot N}{min ( {P}_{SS} )} )} ] ( if \frac{max ( {P}_{SS} ) \cdot N}{min ( {P}_{SS} )} is even ) .$$

That is, the lengths of c^{P}^{_{Actual}} and b^{P}^{_{Actual}} are L_{bit}·(max(P_{SS})/P_{Actual})·N.

At this time, the number of times of the blind decoding required for the UE to decode the PBCH may be the number of times of the following Equation 7.

$$\frac{max ( {P}_{SS} ) \cdot N}{min ( {P}_{SS} )} \qquad [ Equation 7 ]$$

The initial access terminal receives and decodes the PBCH on the assumption of the P_{IA}. At this time, the blind decoding is performed by the number of times as shown in the above Equation 7 which is the total number of scrambling sequences. In addition, if the CONNECTED terminal or the IDLE terminal knows the P_{SS} allocated to the base station, the PBCH is received and decoded on the assumption of the P_{SS}. At this time, the blind decoding is performed by the number of times described in the above <Equation 7> which is the total number of possible scrambling sequences. That is, the LSB bit

$${log}_{2}^{\frac{max ( {P}_{SS} ) \cdot N}{min ( {P}_{SS} )}}$$

(bits) of the system frame number is obtained through the blind decoding.

<Method 2-1-1-2: Case in which PBCH TTI is not Fixed and P_{Actual} Information is not Transmitted Through TSS>

P_{Actual} information may be transmitted through the synchronization signal, in particular, the TSS, and the terminal may infer the number of times of the blind decoding and the corresponding scrambling sequence using the information. In addition, the base station may generate the information bit block b and the scrambling sequence c differently depending on the P_{Actual} value.

When the period information that the base station transmits through the TSS is the P_{Actual}, the M_{bit}^{P}^{_{Actual}} information bit blocks b(0), . . . , b(M_{bit}^{P}^{_{Actual}}−1) to be transmitted on the PBCH are scrambled into \tilde{b}(i)=(b(i)+c(i))mod 2 using the cell-specific sequence prior to the modulation. M_{bit}^{P}^{_{Actual}} represents the information bit block size depending on the P_{SS} value, and is represented by the following Equation 8.

M_{bit}^{P}^{_{Actual}}=L_{bit}·(max(P_{SS})/P_{Actual})·N [Equation 8]

The L_{bit} represents the payload size including the CRC of the PBCH, and N represents the minimum number of times of combining for robust reception of the PBCH of the terminal.

c^{P}^{_{Actual}} is a sequence of L_{bit}·(max(P_{SS})/P_{Actual})·N length.

(n_{f}·T_{frame})mod(P_{Actual}·N)=0 [Equation 9]

c^{P}^{_{Actual}} may be initialized to be cᵢₙᵢₜ=N_{ID}^{cell} in an n_{f} system frame satisfying the above Equation 9 (n_{f}·T_{frame})mod (P_{Actual}·N)=0. In the above Equation (9), T_{frame} is 10 ms. b^{P}^{_{Actual}} is the information bit block having a length of L_{bit}·(max(P_{SS})/P_{Actual})·N length

At this time, the initial access terminal receives the signal based on the P_{Actual}, but since the terminal having received the P_{SS} value from the base station will decode the PBCH based on this value, the required number of times of the blind decoding is the number of times of the following Equation 10.

$$\frac{max ( {P}_{SS} ) \cdot N}{{P}_{Actual}} \qquad [ Equation 10 ]$$

<Method 2-1-1-3: Case in which PBCH TTI is not Fixed and P_{Actual} Information is not Transmitted Through TSS>

Since the minimum P_{SS} that may be transmitted by the base station may be smaller than the P_{IA}, the scrambling sequence applied at the time of PBCH transmission should be changed in units of the minimum allowable P_{SS} value (hereinafter, expressed by min (P_{SS})), and the scrambling sequence should be reset based on the PBCH TTI value (hereinafter, expressed by P_{PBCH}). For example, if the PBCH TTI is 80 ms and the minimum P_{SS} allowed in the system is 5 ms, the terminal should test the hypothesis of 16 (=80 ms/5 ms) through the blind decoding to obtain the half-frame timing index and LSB information (corresponding to 4 bits). That is, the PBCH is decoded by applying 16 different scrambling sequences, and the LSB bit and the half-frame timing index (corresponding to 1 bit) may be inferred according to whether the decoding succeeds. The base station may transmit the SS burst set with a value larger than 5 ms. At this time, 16 different scrambling sequences are applied to bits configuring the PBCH redundancy versions (RV) transmitted within 80 ms and thus the terminal helps find the successful system frame number. The PBCH RV may be divided into units of the SS burst set. That is, the PBCHs transmitted through the SS blocks transmitted in the same SS burst set may be recognized as the same RV. However, this does not mean that the terminal may not receive and combine multiple SS blocks in the SS burst. The PBCH RVs in the PBCH TTI all include the same MSB information.

For example, the base station in which the actual SS burst set transmission period is 5 ms sequentially applies scrambling sequences Nos. 1 to 16 to bits configuring the PBCH RVs transmitted at locations of 0/5/10/15/20/25/30/35/40/45/50/55/60/65/70/75 ms within the PBCH TTI of 80 ms. On the other hand, the base station in which the actual SS burst set transmission period is 20 ms sequentially applies scrambling sequence Nos. 1/5/9/13 to the PBCH RVs transmitted at locations of 0/20/40/60 ms in the PBCH TTI. If the base station in which the actual SS burst set transmission period is 160 ms (two times of PBCH TTI) applies the scrambling sequence Nos. 1/5/9/13 to the PBCH RVs transmitted at locations of 0/20/40/60 ms.

If the P_{Actual} does not exceed the P_{PBCH}, the P_{Actual} of the Equations used in the present embodiment means the period in which the actual base station transmits the SS burst set. However, if the P_{Actual} exceeds the P_{PBCH}, the P_{Actual} value of the Equations used in the present embodiment should be replaced by the P_{PBCH}.

M_{bit}^{P}^{_{Actual}} information bit blocks b^{P}^{_{Actual}}(0), . . . , b^{P}^{_{Actual}}(M_{bit}^{P}^{_{Actual}}−1) to be transmitted on the PBCH are scrambled into \tilde{b}^{P}^{_{Actual}}(i)=(b^{P}^{_{Actual}}(i)+c^{P}^{_{Actual}}(i))mod 2 using the cell-specific sequence prior to the modulation. M_{bit}^{P}^{_{Actual}} represents the information bit block size depending on the P_{Actual} value, and is represented by the following Equation 11.

M_{bit}^{P}^{_{Actual}}=L_{bit}·(P_{PBCH}/P_{Actual}) [Equation 11]

The L_{bit} represents a payload size including the CRC of the PBCH.

c is a sequence of L_{bit}·(P_{PBCH}/min(P_{SS}))·N length

(n_{f}·T_{frame})mod(P_{PBCH})=0 [Equation 12]

c may be initialized to be cᵢₙᵢₜ=N_{ID}^{cell} in the n_{f} system frame satisfying the above Equation 12 (n_{f}·T_{frame})mod(P_{PBCH})=0. T_{frame} is 10 ms. b is an information bit block having a length of L_{bit}·(P_{PBCH}/min(P_{SS}))·N. c^{P}^{_{Actual}} represents a scrambling sequence applied to the PBCH information bit block depending on the P_{Actual} value, and has the same value as a part or all of c. When the scrambling sequence c is represented by multiple sequences cⱼ having a length of L_{bit}, this may be represented by the following Equation 13.

$$c = [ {c}_{0} , {c}_{1} , … , {c}_{( \frac{{P}_{PBCH}}{min ( {P}_{SS} )} )} ] \qquad [ Equation 13 ]$$

Each cⱼ is involved in the scrambling of the information bit block transmitted in one SS burst set. c^{P}^{_{Actual}} is configured of an ordered list of cⱼ satisfying j mod(P_{Actual}/min(P_{SS}))=0. For example, if P_{Actual}=10 ms and min (P_{SS})=5 ms, then

$${c}^{{P}_{Actual}} = [ {c}_{0} , {c}_{1} , … , {c}_{( \frac{{P}_{PBCH}}{min ( {P}_{SS} )} )} ] ( if \frac{max ( {P}_{SS} ) \cdot N}{min ( {P}_{SS} )} is even ) .$$

b^{P}^{_{Actual}} represents the information bit block depending on the P_{Actual} value, and has the same value as a part or all of b. If the information bit block b is represented by multiple blocks b₁ having a length of L_{bit}, this is represented by the following <Equation 14>.

$$b = [ {b}_{0} , {b}_{1} , … , {b}_{( \frac{{P}_{PBCH}}{min ( {P}_{SS} )} )} ] \qquad [ Equation 14 ]$$

b^{P}^{_{Actual}} is configured of an ordered list of bⱼ satisfying j mod(P_{Actual}/min(P_{SS}))=0. For example, if P_{Actual}=10 ms and min (P_{SS})=5 ms, then

$${b}^{{P}_{Actual}} = [ {b}_{0} , {b}_{1} , … , {b}_{( \frac{max ( {P}_{SS} ) \cdot N}{min ( {P}_{SS} )} )} ] ( if \frac{max ( {P}_{SS} ) \cdot N}{min ( {P}_{SS} )} is even ) .$$

At this time, the number of times of the blind decoding required for the terminal to decode each PBCH RV may be calculated by the following <Equation 15>.

$$\frac{{P}_{PBCH}}{min ( {P}_{SS} )} \qquad [ Equation 15 ]$$

The initial access and CONN/IDLE terminal receives and decodes the respective PBCH RVs. At this time, the blind decoding is performed by the number of times as shown in the above Equation 15 which is the total number of possible scrambling sequences.

<Method 2-1-1-4: Case in which PBCH TTI is Fixed and P_{Actual} Information is not Transmitted Through TSS>

M_{bit}^{P}^{_{Actual}} information bit blocks b^{P}^{_{Actual}}(0), . . . , b^{P}^{_{Actual}}(M_{bit}^{P}^{_{Actual}}−1) to be transmitted on the PBCH are scrambled into \tilde{b}^{P}^{_{Actual}}(i)=(b^{P}^{_{Actual}}(i)+c^{P}^{_{Actual}}(i))mod 2 using the cell-specific sequence prior to the modulation. If the P_{Actual} does not exceed the P_{PBCH}, the P_{Actual} of the Equations used in the present embodiment means the period in which the actual base station transmits the SS burst set. However, if the P_{Actual} exceeds the P_{PBCH}, the P_{Actual} value of the Equations used in the present embodiment should be replaced by the P_{PBCH}.

M_{bit}^{P}^{_{Actual}} represents an information bit block size depending on the P_{Actual} value, and is represented by the above Equation 11. The L_{bit} represents a payload size including the CRC of the PBCH.

c^{P}^{_{Actual}} is a sequence of L_{bit}·(P_{PBCH}/P_{Actual})·N, and may be initialized to be cᵢₙᵢₜ=N_{ID}^{cell} in the n_{f} system frame satisfying the above <Equation 12>. T_{frame} is 10 M S b^{P}^{_{Actual}} is the information bit block having a length of L_{bit}·(P_{PBCH}/P_{Actual})·N.

At this time, the initial access terminal receives the signal based on the P_{Actual}, but since the terminal having received the P_{SS} value from the base station will decode the PBCH based on this value, the required number of times of the blind decoding may be set to be the number of times of the following Equation 16.

$$\frac{{P}_{PBCH}}{{P}_{Actual}} \qquad [ Equation 16 ]$$

<Method 2-1-2. Acquisition of Half-Frame Timing Index and System Frame Number Information Through PBCH: Half-Frame Timing Index, LSB Transmission in which CRC Cyclic Shift is Applied to Redundancy Version (RV), MSB Transmission in MIB>

In the present embodiment, a method of performing the PBCH blind decoding to obtain the half-frame timing index and the LSB among the system frame numbers is proposed. In particular, the operations of the base station/terminal will be described when the base station applies the CRC cyclic shift to the redundancy version (RV) of the base station in order to indicate the half-frame timing index information and the LSB at the time of the blind decoding.

For example, if the PBCH TTI is 80 ms and the minimum P_{SS} allowed in the system is 5 ms, the terminal should test the hypothesis of 16 (=80 ms/5 ms) through the blind decoding to obtain the half-frame timing index and the LSB (corresponding to 4 bits). At this time, unlike the method 2-1-1, the half-frame timing index information (corresponding to 1 bit) and the LSB (3 bits) may be represented through the CRC cyclic shift.

The PBCH RV may be divided into units of the SS burst set. That is, the PBCHs transmitted through the SS blocks transmitted in the same SS burst set may be recognized as the same RV. However, this does not mean that the terminal may not receive and combine multiple SS blocks in the SS burst. The PBCH RVs in the PBCH TTI all include the same MSB information.

According to an example, 4 scrambling sequences may be applied bits in the PBCH RV, and 4 kinds of CRC cyclic shifts of the PBCH RVs may be differently combined to perform 16 hypotheses. For example, the base station in which the actual SS burst set transmission period is 5 ms may sequentially apply scrambling sequences Nos. 1/1/1/1/2/2/2/2/3/3/3/3/4/4/4/4 to bits configuring the PBCH RVs transmitted at locations of 0/5/10/15/20/25/30/35/40/45/50/55/60/65/70/75 ms in the PBCH TTI of 80 ms, and at the same time, applies the CRC cyclic shift by 0/1/2/3/0/1/2/3/0/1/2/3/0/1/2/3, such that the terminal may infer the half-frame timing index and the LSB through the PBCH blind decoding. On the other hand, the base station in which the actual SS burst set transmission period is 20 ms, the base station may sequentially apply scrambling sequences Nos. 1/2/3/4 to bits configuring the PBCH RVs transmitted at locations of 0/20/20/40/60 ms and at the same time, applies the CRC cyclic shift of 0/0/0/0, such that the terminal may infer the half-frame timing index and the LSB through the PBCH blind decoding.

According to another example, 16 hypotheses may be performed by applying 4 CRC cyclic shifts to bit groups configuring the PBCH RVs and applying 4 kinds of CRC cyclic shifts between the bit groups configuring the PBCH RVs and combining them. For example, the base station in which the actual SS burst set transmission period is 5 ms may sequentially apply a cyclic shift by 0/0/0/0/1/1/1/1/2/2/2/2/3/3/3/3 to bit groups configuring the PBCH RVs transmitted at locations of 0/5/10/15/20/25/30/35/40/45/50/55/60/65/70/75 ms in the PBCH TTI of 80 ms and at the same time applies the cyclic shift by 0/1/2/3/0/1/2/3/0/1/2/3/0/1/2/3 between the bit groups configuring the PBCH RVs, such that the terminal may infer the half-frame timing index and the LSB through the PBCH blind decoding. On the other hand, the base station in which the actual SS burst set transmission period is 20 ms sequentially applies the cyclic shifts of 0/1/2/3 to the bits configuring the PBCH RVs transmitted at locations of 0/20/20/40/60 ms in the PBCH TTI and at the same time, applying the cyclic shift of 0/0/0/0 between the bit groups configuring the PBCH RVs, such that the terminal may infer the half-frame timing index and the LSB through the PBCH blind decoding.

<Method 2-2. Acquisition of Half-Frame Timing Index and System Frame Number Information on PBCH and TSS: Acquisition of MSB Information in MIB, LSB Information Through PBCH Blind Decoding, and Half-Frame Timing Index Information Through TSS Reception>

In order to obtain the system frame number information, a method for acquiring the LSB information (3 bits) through the PBCH blind decoding, acquiring the half-frame timing index information (corresponding to 1 bit) through the TSS reception, and transmitting MSB information in the MIB is possible. That is, the LSB may be transmitted in the same scheme as described in the method 2-1-1 or the method 2-1-2, and the half-frame timing index information may be transmitted through the TSS as described in the method 1. In this case, the TSS may include the SS burst set start point information or the slot start point information, for example, as described in the method 1, in addition to the half-frame timing index information. In addition, the TSS may also include the information on the number of SS blocks actually transmitted in the SS and/or whether the system is single-beam based or multi-beam based.

The PBCH RV may be divided into units of the SS burst set. That is, the PBCHs transmitted through the SS blocks transmitted in the same SS burst set may be recognized as the same RV. However, this does not mean that the terminal may not receive and combine multiple SS blocks in the SS burst. The PBCH RVs in the PBCH TTI all include the same MSB information.

For example, if the PBCH TTI is 80 ms and the minimum P_{SS} allowed in the system is 5 ms, the terminal should test the hypothesis of 16 (=80 ms/5 ms) through the blind decoding to obtain the half-frame timing index and the LSB (corresponding to 4 bits). At this time, the LSB (corresponding to 3 bits) may apply 8 scrambling sequences to the bits in the PBCH RV, and 1 bit may be transmitted through the TSS. For example, the base station in which the actual SS burst set transmission period is 5 ms sequentially applies scrambling sequences Nos. 1/2/1/2/1/2/1/2/1/2/1/2/1/2/1/2 to bits configuring the PBCH RVs within the SS burst set transmitted at locations of 0/5/10/15/20/25/30/35/40/45/50/55/60/65/70/75 ms in the PBCH TTI, and at the same time, uses sequences Nos. 1/1/2/2/3/3/4/4/5/5/6/6/7/7/8/2 at the time of transmitting the TSS within the SS burst set, such that the terminal may infer the LSB through the information in the TSS and the half-frame timing index through the PBCH blind decoding. On the other hand, the base station in which the actual SS burst set transmission period is 20 ms sequentially applies scrambling sequences Nos. 1/3/5/7 bits to bits configuring the PBCH RVs within the SS burst set transmitted at locations of 0/20/40/60 ms in the PBCH TTI and at the same time, uses sequences Nos. 1/1/1/1 at the time of transmitting the TSS within the SS burst set, such that the terminal may infer the half-frame timing index through the information in the TSS and infer the LSB through the PBCH blind decoding. A role of the sequences configuring the scrambling sequence and the TSS may be reversed. For example, the base station in which the actual SS burst set transmission period is 5 ms sequentially applies scrambling sequences Nos. 1/2/1/2/1/2/1/2/1/2/1/2/1/2/1/2 to bits configuring the PBCH RVs within the SS burst set transmitted at locations of 0/5/10/15/20/25/30/35/40/45/50/55/60/65/70/75 ms in the PBCH TTI, and at the same time, uses sequences Nos. 1/1/2/2/3/3/4/4/5/5/6/6/7/7/8/8 at the time of transmitting the TSS within the SS burst set, such that the terminal may infer the LSB through the information in the TSS and the half-frame timing index through the PBCH blind decoding. On the other hand, the base station in which the actual SS burst set transmission period is 20 ms sequentially applies scrambling sequences Nos. 1/3/5/7 bits to bits configuring the PBCH RVs within the SS burst set transmitted at locations of 0/20/40/60 ms in the PBCH TTI and at the same time, uses sequences Nos. 1/1/1/1 at the time of transmitting the TSS within the SS burst set, such that the terminal may infer the half-frame timing index through the information in the TSS and infer the LSB through the PBCH blind decoding. In this case, the information corresponding to 3 bits is transmitted through the TSS and the information corresponding to one bit is transmitted through the PBCH blind decoding.

<Method 2-3. Acquisition of Half-Frame Timing Index and System Frame Number Information Through PBCH and RMSI or PBCH, TSS and RMSI: MSB Information in MIB and RMSI, Acquisition of LSB Information and Half-Frame Timing Index Information by Method for Acquiring LSB Information and Half-Frame Timing Index Information Introduced in Method 2-1/2-2>

Considering that only limited information may be transmitted in the MIB, the MSB can be distributedly transmitted to the MIB and the RMSI. At this time, the MIB of the PBCH RVs transmitted by the base station for one PBCH TTI transmits the same MSB value. For example, the MSB value in the MIB is determined depending on the relative distance on the time axis between the PBCH and the RMSI transmission channel transmitted by the base station, and the RMSI may include a common MSB value for the corresponding PBCH. If the system half-frame timing index No. 0 is 0 ms, the RMSI transmission period is 320 ms, the RMSI transmission channel start point is 330 ms, and the PBCH TTI is 80 ms, PBCH TTI No. 4 is included (320 ms/80 ms) for one period RMSI. In this case, the PBCH RVs transmitted in each PBCH TTI need only to transmit 2-bit MSB information in the payload of the MIB, and the RMIS may include the remaining MSB information. In addition, the LSB 3 bits and the half-frame timing index information may be acquired through the PBCH blind decoding by the scheme for acquiring the LSB information and the half-frame timing index information disclosed in the methods 2-1/2-2. If the total SFN is 10 bits, the MSB transmitted by the RMSI becomes 5 bits (=10−2−3) in total. This value is a common number to a radio frame for 320 ms corresponding to the PBCH TTI. The terminal combines the TSS reception and the PBCH RVs or combines the PBCH RVs to acquire the half-frame timing index information and the LSB and at the same time the MSB in the MIB. The terminal determines whether to receive the PBCH in any PBCH TTI among 0 to 80 ms/80 to 160 ms/160 to 240 ms/240 to 320 ms based on MSB 2 bits (in the present embodiment, which is divided into 00, 01, 10, 11). The start point of the PBCH TTI can be determined through the LSB and the half-frame timing index information. Thereafter, the terminal receives the RMIS transmission point (point 330 ms) to acquire the remaining MSB information.

<Method 2-4. Acquisition of Half-Frame Timing Index and System Frame Number Information on PBCH and SSS: Acquisition of MSB Information in MIB, LSB Information Through PBCH Blind Decoding, and Half-Frame Timing Index Information Through SSS Reception>

In order to obtain the system frame number information, a method for acquiring the LSB information (3 bits) through the PBCH blind decoding, acquiring the half-frame timing index information (corresponding to 1 bit) through the SSS reception, and transmitting MSB information in the MIB (methods 2-1 and 2-2) or the MIB and the RMSI (method 2-3) is possible. That is, the LSB may be transmitted in the same scheme as described in the method 2-1-1 or the method 2-1-2, and the half-frame timing index information may be transmitted through the SSS.

The PBCH RV may be divided into units of the SS burst set. That is, the PBCHs transmitted through the SS blocks transmitted in the same SS burst set may be recognized as the same RV. However, this does not mean that the terminal may not receive and combine multiple SS blocks in the SS burst. The PBCH RVs in the PBCH TTI all include the same MSB information.

For example, if the PBCH TTI is 80 ms and the minimum P_{SS} allowed in the system is 5 ms, the terminal should test (corresponding to 4 bits) the hypothesis of 16 (=80 ms/5 ms) to obtain the half-frame timing index and the LSB. At this time, the LSB (corresponding to 3 bits) may apply 8 scrambling sequences to the bits in the PBCH RV, and 1 bit may be transmitted through the SSS. For example, the base station in which the actual SS burst set transmission period is 5 ms sequentially applies scrambling sequences Nos. /1/2/2/3/3/4/4/5/5/6/6/7/7/8/8 to bits configuring the PBCH RVs within the SS burst set transmitted at locations of 0/5/10/15/20/25/30/35/40/45/50/55/60/65/70/75 ms in the PBCH TTI, and at the same time, uses sequences Nos. 1/2/1/2/1/2/1/2/1/2/1/2/1/2/1/2 at the time of transmitting the TSS within the SS burst set, such that the terminal may infer the LSB through the information in the SSS and the half-frame timing index through the PBCH blind decoding. On the other hand, the base station in which the actual SS burst set transmission period is 20 ms sequentially applies scrambling sequences Nos. 1/3/5/7 bits to bits configuring the PBCH RVs within the SS burst set transmitted at locations of 0/20/40/60 ms in the PBCH TTI and at the same time, uses sequences Nos. 1/1/1/1 at the time of transmitting the SSS within the SS burst set, such that the terminal may infer the half-frame timing index through the information in the SSS and infer the LSB through the PBCH blind decoding. The SSS may perform a function of transmitting a part of a physical cell-ID together with the transmission of the half-frame timing index information. A role of the sequences configuring the scrambling sequence and the TSS may be reversed. For example, the base station in which the actual SS burst set transmission period is 5 ms sequentially applies scrambling sequences Nos. 1/2/1/2/1/2/1/2/1/2/1/2/1/2/1/2 to bits configuring the PBCH RVs within the SS burst set transmitted at locations of 0/5/10/15/20/25/30/35/40/45/50/55/60/65/70/75 ms in the PBCH TTI of 80 ms, and at the same time, uses sequences Nos. 1/1/2/2/3/3/4/4/5/5/6/6/7/7/8/8 at the time of transmitting the SSS within the SS burst set, such that the terminal may infer the LSB through the information in the SSS and the half-frame timing index through the PBCH blind decoding. On the other hand, the base station in which the actual SS burst set transmission period is 20 ms sequentially applies scrambling sequences Nos. 1/3/5/7 bits to bits configuring the PBCH RVs within the SS burst set transmitted at locations of 0/20/40/60 ms in the PBCH TTI and at the same time, uses sequences Nos. 1/1/1/1 at the time of transmitting the SSS within the SS burst set, such that the terminal may infer the half-frame timing index through the information in the SSS and infer the LSB through the PBCH blind decoding. In this case, the information corresponding to 3 bits is transmitted through the SSS and the information corresponding to one bit is transmitted through the PBCH blind decoding.

<Method 2-5. Acquisition of Half-Frame Timing Index and System Frame Number Information Through PBCH and TSS: Acquisition of Total System Frame Number in MIB, Acquisition of Half-Frame Timing Index Information Through TSS>

The system frame number can be transmitted to the MIB, and the half-frame timing index information can be transmitted through the TSS. Therefore, in the present embodiment, all the PBCH RVs in the PBCH TTI do not have the same MIB information.

For example, if the PBCH TTI is 80 ms and the minimum P_{SS} allowed in the system is 5 ms, the MIB bits included within the SS burst sets transmitted in one radio frame may include the system frame number, and the half-frame timing index information may be transmitted through the TSS. For example, the base station in which the actual SS burst set transmission period is 5 ms may use sequences Nos. 1/2/1/2/1/2/1/2/1/2/1/2/1/2/1/2 transmitted at locations of 0/5/10/15/20/25/30/35/40/45/50/55/60/65/70/75 ms in the PBCH TTI of 80 ms, such that the terminal may infer the half-frame timing index through the information in the TSS and infer the system frame number through the PBCH decoding. On the other hand, the base station in which the actual SS burst set transmission period is 20 ms uses sequences Nos. 1/1/1/1 at the time of the TSS transmission within the SS burst set transmitted at the 0/20/20/40/60 ms position in the PBCH TTI, such that the terminal may infer the half-frame timing index through the information in the TSS and infer the system frame number through the PBCH decoding.

The change in the bits (explicit bits) in the MIB for each SS block transmitted in the PBCH TTI does not mean that the terminal may not combine the plurality of SS blocks within the SS burst set at the time of the PBCH decoding or combine the plurality of SS blocks in multiple SS burst sets. However, the blind decoding may be accompanied at the time of combining the plurality of SS blocks to find the system frame number in the MIB.

<Method 2-6. Acquisition of Half-Frame Timing Index and System Frame Number Information Through PBCH and SSS: Acquisition of Total System Frame Number in MIB, Acquisition of Half-Frame Timing Index Information Through SSS>

The system frame number can be transmitted to the MIB, and the half-frame timing index information can be transmitted through the SSS. Therefore, in the present embodiment, all the PBCH RVs in the PBCH TTI do not have the same MIB information.

For example, if the PBCH TTI is 80 ms and the minimum P_{SS} allowed in the system is 5 ms, the MIB bits included within the SS burst sets transmitted in one radio frame may include the system frame number, and the half-frame timing index information may be transmitted through the SSS. For example, the base station in which the actual SS burst set transmission period is 5 ms may use sequences Nos. 1/2/1/2/1/2/1/2/1/2/1/2/1/2/1/2 transmitted at locations of 0/5/10/15/20/25/30/35/40/45/50/55/60/65/70/75 ms in the PBCH TTI of 80 ms, such that the terminal may infer the half-frame timing index through the information in the SSS and infer the system frame number through the PBCH decoding. On the other hand, the base station in which the actual SS burst set transmission period is 20 ms uses sequences Nos. 1/1/1/1 at the time of the SSS transmission within the SS burst set transmitted at the 0/20/20/40/60 ms position in the PBCH TTI, such that the terminal may infer the half-frame timing index through the information in the TSS and infer the system frame number through the PBCH decoding. The SSS may perform a function of transmitting a part of a physical cell-ID together with the transmission of the half-frame timing index information.

The change in the bits (explicit bits) in the MIB for each SS block transmitted in the PBCH TTI does not mean that the terminal may not combine the plurality of SS blocks within the SS burst set at the time of the PBCH decoding or combine the plurality of SS blocks in multiple SS burst sets. However, the blind decoding may be accompanied at the time of combining the plurality of SS blocks to find the system frame number in the MIB.

<Method 2-7. Acquisition of Half-Frame Timing Index and System Frame Number Information Through PBCH and SSS: Acquisition of Total System Frame Number in MIB, Acquisition of Half-Frame Timing Index Information Through PBCH Blind Decoding>

The system frame number is transmitted to the MIB, and the half-frame timing index information can be transmitted by applying different scrambling sequences, CRC cyclic shifts or the like for each PBCH RV. Therefore, in the present embodiment, all the PBCH RVs in the PBCH TTI do not have the same MIB information.

For example, if the PBCH TTI is 80 ms and the minimum P_{SS} allowed in the system is 5 ms, the MIB bits included within the SS burst sets transmitted in one radio frame may include the system frame number, and the half-frame timing index information can be transmitted by applying different scrambling sequences, CRC cyclic shifts or the like for each PBCH RV. For example, the base station in which the actual SS burst set transmission period is 5 ms uses sequences Nos. 1/2/1/2/1/2/1/2/1/2/1/2/ for the PBCH information bits for each PBCH RV in one radio frame, such that the terminal may infer the system half-frame timing index through the PBCH blind decoding. On the other hand, the base station in which the actual SS burst set transmission period is 20 ms uses sequences Nos. 1/1/1/1 for the PBCH information bits for each PBCH RV transmitted at locations of 0/20/40/60 ms in the PBCH TTI, thereby inferring the system half-frame timing index through the PBCH decoding.

The change in the bits (explicit bits) in the MIB for each SS block transmitted in the PBCH TTI does not mean that the terminal may not combine the plurality of SS blocks within the SS burst set at the time of the PBCH decoding or combine the plurality of SS blocks in multiple SS burst sets. However, the blind decoding may be accompanied at the time of combining the plurality of SS blocks to find the system frame number in the MIB.

<Method 2-8. Acquisition of Half-Frame Timing Index and System Frame Number Information Through PBCH and TSS: Acquisition of MSB and Half-Frame Timing Index Information in MIB, Acquisition of LSB Information Through TSS>

The MSB and the half-frame timing index information are transmitted to the MIB and the LSB may be transmitted through the TSS. Therefore, in the present embodiment, all the SS blocks in the PBCH RV in the PBCH TTI do not have the same MIB information.

For example, if the PBCH TTI is 80 ms and the minimum P_{SS} allowed in the system is 5 ms, then the SS burst sets transmitted in one radio frame will have different MIB bits depending on whether they are transmitted at a location of 0 ms or 5 ms. In addition, 8 hypotheses (corresponding to 3 bits) may be transmitted through the TSS to transmit the LSB. For example, the base station in which the actual SS burst set transmission period is 5 ms may use sequences Nos. 1/1/2/2/3/3/4/4/5/5/6/6/7/7/8/8 transmitted at locations of 0/5/10/15/20/25/30/35/40/45/50/55/60/65/70/75 ms in the PBCH TTI of 80 ms, such that the terminal may infer the LSB through the information in the TSS and infer the MSB and the half-frame timing index through the PBCH decoding. On the other hand, the base station in which the actual SS burst set transmission period is 20 ms uses sequences Nos. 1/3/5/7 at the time of the TSS transmission within the SS burst set transmitted at the 0/20/20/40/60 ms position in the PBCH TTI, such that the terminal may infer the LSB through the information in the TSS and infer the MSB and the system frame number through the PBCH decoding.

The change in the bits (explicit bits) in the MIB for each SS block transmitted in the PBCH TTI does not mean that the terminal may not combine the plurality of SS blocks within the SS burst set at the time of the PBCH decoding or combine the plurality of SS blocks in multiple SS burst sets. However, the blind decoding may be accompanied at the time of combining the plurality of SS blocks to find the system frame number in the MIB.

<Method 2-9. Acquisition of Half-Frame Timing Index and System Frame Number Information Through PBCH and SSS: Acquisition of MSB and Half-Frame Timing Index Information in MIB, Acquisition of LSB Information Through SSS>

The MSB and the half-frame timing index information are transmitted to the MIB and the LSB may be transmitted through the SSS. Therefore, in the present embodiment, all the SS blocks in the PBCH RV in the PBCH TTI do not have the same MIB information.

For example, if the PBCH TTI is 80 ms and the minimum P_{SS} allowed in the system is 5 ms, then the SS burst sets transmitted in one radio frame will have different MIB bits depending on whether they are transmitted at a location of 0 ms or 5 ms. In addition, 8 hypotheses (corresponding to 3 bits) may be transmitted through the TSS to transmit the LSB. For example, the base station in which the actual SS burst set transmission period is 5 ms may use sequences Nos. 1/1/2/2/3/3/4/4/5/5/6/6/7/7/8/8 transmitted at locations of 0/5/10/15/20/25/30/35/40/45/50/55/60/65/70/75 ms in the PBCH TTI of 80 ms, such that the terminal may infer the LSB through the information in the SSS and infer the MSB and the half-frame timing index through the PBCH decoding. On the other hand, the base station in which the actual SS burst set transmission period is 20 ms uses sequences Nos. 1/3/5/7 at the time of the SSS transmission within the SS burst set transmitted at the 0/20/20/40/60 ms position in the PBCH TTI, such that the terminal may infer the LSB through the information in the SSS and infer the MSB and the system frame number through the PBCH decoding. The SSS may perform a function of transmitting a part of a physical cell-ID together with the transmission of the LSB information.

The change in the bits (explicit bits) in the MIB for each SS block transmitted in the PBCH TTI does not mean that the terminal may not combine the plurality of SS blocks within the SS burst set at the time of the PBCH decoding or combine the plurality of SS blocks in multiple SS burst sets. However, the blind decoding may be accompanied at the time of combining the plurality of SS blocks to find the system frame number in the MIB.

<Method 2-10. Acquisition of Half-Frame Timing Index and System Frame Number Information Through PBCH and SSS: Acquisition of MSB and Half-Frame Timing Index Information in MIB, Acquisition of LSB Information Through SSS>

The MSB and the half-frame timing index information are transmitted to the MIB, and the LSB information can be transmitted by applying different scrambling sequences, CRC cyclic shifts or the like for each PBCH RV. Therefore, in the present embodiment, all the PBCH RVs in the PBCH TTI do not have the same MIB information.

For example, if the PBCH TTI is 80 ms and the minimum P_{SS} allowed in the system is 5 ms, the MIB bits included within the SS burst sets transmitted in one radio frame may include the MSB and the system frame number, and the LSB information can be transmitted by applying different scrambling sequences, CRC cyclic shifts or the like for each PBCH RV. For example, the base station in which the actual SS burst set transmission period is 5 ms uses sequences Nos. 1/1/2/2/3/3/4/4/5/5/6/6/7/7/8/8 for the PBCH information bits for each PBCH RV, such that the terminal may infer through the PBCH blind decoding and infer the LSB and the MSB and the half-frame timing index through the PBCH decoding. On the other hand, the base station in which the actual SS burst set transmission period is 20 ms uses sequences Nos. 1/1/1/1 for the PBCH information bits in the PBCH RV transmitted at locations of 0/20/40/60 ms in the PBCH TTI, such that the terminal may infer the LSB through the PBCH blind decoding and infer the MSB and the half-frame timing index through the PBCH decoding.

The change in the bits (explicit bits) in the MIB for each SS block transmitted in the PBCH TTI does not mean that the terminal may not combine the plurality of SS blocks within the SS burst set at the time of the PBCH decoding or combine the plurality of SS blocks in multiple SS burst sets. However, the blind decoding may be accompanied at the time of combining the plurality of SS blocks to find the system frame number in the MIB.

<Method 2-11. Acquisition of Half-Frame Timing Index and System Frame Number Information Through PBCH: Acquisition of MSB, LSB, and Half-Frame Timing Index Information in MIB>

It is possible to transmit the total system frame number and the half-frame timing index information to the MIB. Therefore, in the present embodiment, all the PBCH RVs in the PBCH TTI do not have the same MIB information.

The change in the bits (explicit bits) in the MIB for each SS block transmitted in the PBCH TTI does not mean that the terminal may not combine the plurality of SS blocks within the SS burst set at the time of the PBCH decoding or combine the plurality of SS blocks in multiple SS burst sets. However, the blind decoding may be accompanied at the time of combining the plurality of SS blocks to find the system frame number in the MIB.

<Method 3-1. Acquisition of Slot/Half-Frame Timing Index/System Frame Number Information Through PBCH: MSB Transmission in MIB, SS Burst Set Start Point/Half-Frame Timing Index, and LSB Transmission Using Scrambling Sequence>

The present embodiment describes a method of acquiring the SS burst set start point/half-frame timing index/system frame number through only the PBCH. It is possible to transmit the MSB in the MIB and transmit the SS burst set start point/half-frame timing index and the LSB by applying different scrambling sequences to the SS blocks in the PBCH RV and the RV as described in the method 2-1-1.

The PBCH RV may be divided into units of the SS burst set. That is, the PBCHs transmitted through the SS blocks transmitted in the same SS burst set may be recognized as the same RV. However, this does not mean that the terminal may not receive and combine multiple SS blocks in the SS burst. The PBCH RVs in the PBCH TTI all include the same MSB information.

For example, if the PBCH TTI is 80 ms, the minimum P_{SS} allowed in the system is 5 ms, and a maximum of 64 SS blocks within one SS burst set may be transmitted, the terminal should test (corresponding to 10 bits) 1024 (=80 ms/5 ms×64) hypotheses through the blind decoding. For example, the base station in which the actual SS burst set transmission period is 5 ms sequentially applies scrambling sequences Nos. 1/2/3/ . . . /1024 to the SS blocks of the PBCH RVs transmitted at locations of 0/5/10/15/20/25/30/35/40/45/50/55/60/65/70/75 ms in the PBCH TTI of 80 ms. To help understanding, it will be described in more detail. Scrambling sequences Nos. 1/2/ . . . /64 are applied to the PBCH bits transmitted from the block within the SS burst set transmitted at a location of 0 ms corresponding to the first PBCH RV. Scrambling sequences Nos. 65/66/ . . . /128 are applied to the PBCH bits transmitted from the block within the SS burst set transmitted at a location of 5 ms corresponding to the second PBCH RV. On the other hand, the base station in which the actual SS burst set transmission period is 20 ms sequentially applies scrambling sequence Nos. 1˜64/207˜320/ . . . to bits sequentially configuring the SS blocks of the PBCH RV within the SS burst set transmitted at locations of 0/20/40/60 ms in the PBCH TTI. To help understanding, it will be described in more detail. Scrambling sequences Nos. 1/2/ . . . /64 are applied to the PBCH bits transmitted from the block within the SS burst set transmitted at a location of 0 ms corresponding to the first PBCH RV. Scrambling sequences Nos. 207/208/ . . . /320 are applied to the PBCH bits transmitted from the block within the SS burst set transmitted at a location of 20 ms corresponding to the second PBCH RV.

<Method 3-2. Acquisition of SS Burst Set Start Point/Half-Frame Timing Index/System Frame Number Information Through PBCH: MSB Transmission in MIB, SS Burst Set Start Point (RV)/Half-Frame Timing Index, and LSB Transmission in which CRC Cyclic Shift is Applied to Redundancy Version>

The present embodiment describes a method of acquiring the SS burst set start point and half-frame timing index/system frame number through only the PBCH. It is possible to transmit the MSB in the MIB and transmit the SS burst set start point/half-frame timing index and the LSB by applying different scrambling sequences and the CRC cyclic shift to the SS blocks in the PBCH RV and the RV as described in the method 2-1-2.

The PBCH RV may be divided into units of the SS burst set. That is, the PBCHs transmitted through the SS blocks transmitted in the same SS burst set may be recognized as the same RV. However, this does not mean that the terminal may not receive and combine multiple SS blocks in the SS burst. The PBCH RVs in the PBCH TTI all include the same MSB information.

<Method 3-3. Including the MSB Transmission in the MIB, Some of the Information for Knowing the SS Burst Set Start Point in the MIB, Including Some of the Information for Knowing the SS Burst Set Start Point Using the Scrambling Sequence/Half-Frame Timing Index Information and LSB Transmission>

The present embodiment describes a method of acquiring the SS burst set start point and half-frame timing index/system frame number through only the PBCH. The MSB in the MIB and the SS burst index information within the SS burst set are transmitted, and the different scrambling sequences are applied to the SS blocks in the SS burst included in the PBCH RV and the RV as described in the method 2-1-1, such that it is possible to transmit the SS block index in the SS burst, the half-frame timing index information, and the LSB. For example, if the PBCH TTI is 80 ms, the minimum P_{SS} allowed in the system is 5 ms, and a maximum of 64 SS blocks in one SS burst set may be transmitted, and if the SS burst set consists of 4 SS burst and one SS burst consists of 16 SS blocks, the terminal should test 256 (=80 ms/5 ms×16) hypotheses (corresponding to 8 bits) through the blind decoding. For example, the base station in which the actual SS burst set transmission period is 5 ms sequentially applies different scrambling sequences to the SS blocks in the SS burst included in the PBCH RV transmitted at locations of 0/5/10/15/20/25/30/35/40/45/50/55/60/65/70/75 ms in the PBCH TTI of 80 ms, and different scrambling sequences for each PBCH RV are also applied.

To help understanding, it will be described in more detail. Scrambling sequences Nos. 1/2/ . . . /16 are applied to the PBCH information bits transmitted from the SS block in the SS burst within the SS burst set transmitted at a location of 0 ms corresponding to the first PBCH RV. Scrambling sequences Nos. 17/18/ . . . /32 are applied to the PBCH information bits transmitted from the SS block in the SS burst within the SS burst set transmitted at a location of 5 ms corresponding to the second PBCH RV. On the other hand, the base station in which the actual SS burst set transmission period is 20 ms sequentially applies scrambling sequence Nos. 1˜16/65˜80/ . . . /193˜208 to PBCH information bits transmitted from the SS blocks in the SS burst in the PBCH RV transmitted at locations of 0/20/40/60 ms in the PBCH TTI.

As another method, the MSB in the MIB and the SS burst index information in the SS burst are transmitted, and the different scrambling sequences are applied to each SS burst in the PBCH RV and the RV as described in the method 2-1-1, such that it is possible to transmit the SS block index within the SS burst set, the half-frame timing index information, and the LSB. For example, if the PBCH TTI is 80 ms, the minimum P_{SS} allowed in the system is 5 ms, and a maximum of 64 SS blocks in one SS burst set may be transmitted, and if the SS burst set consists of 4 SS burst and one SS burst consists of 16 SS blocks, the terminal should test (corresponding to 8 bits) 64 (=80 ms/5 ms×4) hypotheses through the blind decoding. For example, the base station in which the actual SS burst set transmission period is 5 ms sequentially applies different scrambling sequences to the SS blocks in the SS burst in the PBCH RV (SS burst set) transmitted at locations of 0/5/10/15/20/25/30/35/40/45/50/55/60/65/70/75 ms in the PBCH TTI of 80 ms, and different scrambling sequences for each PBCH RV are also applied.

To help understanding, it will be described in more detail. Scrambling sequences Nos. 1/1/1/1/1/1/1/1/1/1/1/1/1/1/1/1/2/2/2/2/2/2/2/2/2/2/2/2/2/2/2/2/3/3/3/3/3/3/3/3/3/3/3/3/3/3/3/3/4/4/4/4/4/4/4/4/4/4/4/4/4/4/4/4 are applied to the PBCH information bits transmitted from the SS block within the SS burst set transmitted at a location of 0 ms corresponding to the first PBCH RV. Scrambling sequences Nos. 5/6/7/8 are applied to each of the PBCH information bits transmitted from the SS block in each SS burst within the SS burst set transmitted at a location of 5 ms corresponding to the second PBCH RV. On the other hand, the base station in which the actual SS burst set transmission period is 20 ms applies scrambling sequence Nos. 1˜4/17˜20/ . . . /49˜52 to PBCH bits transmitted from the SS blocks included in each SS burst in the PBCH RV transmitted at locations of 0/20/40/60 ms in the PBCH TTI.

The PBCH RV may be divided into units of the SS burst set. That is, the PBCHs transmitted through the SS blocks transmitted in the same SS burst set may be recognized as the same RV. However, this does not mean that the terminal may not receive and combine multiple SS blocks in the SS burst.

<Method 3-4: Including the MSB Transmission in the MIB, Some of the Information for Knowing the SS Burst Set Start Point in the MIB, Including Some of the Information for Knowing the SS Burst Set Start Point/Half-Frame Timing Index Information and LSB Transmission in which the CRC Cyclic Shift is Applied to the Redundancy Version (RV)>

The present embodiment describes a method of acquiring the SS burst set start point and half-frame timing index/system frame number through only the PBCH. The MSB in the MIB and the SS burst index information within the SS burst set are transmitted, and the different scrambling sequences and the CRC cyclic shift are applied to the SS blocks in the SS burst in the PBCH RV and the RV as described in the method 2-1-2, such that it is possible to transmit the SS block index in the SS burst, the half-frame timing index information, and the LSB.

As another method, the MSB in the MIB and the SS burst index information in the SS burst are transmitted, and the different scrambling sequences and the CRC cyclic shift are applied to the SS blocks in the SS burst in the PBCH RV and the RV as described in the method 2-1-2, such that it is possible to transmit the SS block index within the SS burst set, the half-frame timing index information, and the LSB.

The PBCH RV may be divided into units of the SS burst set. That is, the PBCHs transmitted through the SS blocks transmitted in the same SS burst set may be recognized as the same RV. However, this does not mean that the terminal may not receive and combine multiple SS blocks in the SS burst.

<Operations of Base Station and Terminal Based on the Above-Described Method>

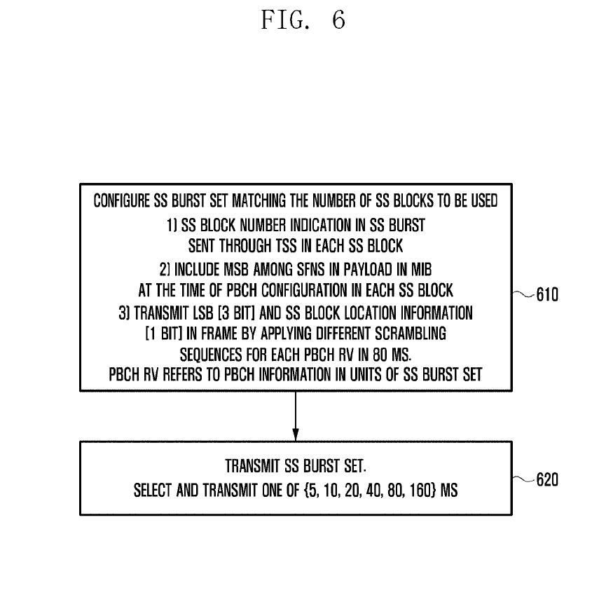

FIG. 6 shows an operation of transmitting the SS burst set from the base station when the method 1-1 and the method 2-1-1 according to an embodiment of the present disclosure are combined.

Referring to FIG. 6, the base station may configure the SS burst set matching the number of SS blocks to be used in operation 610. That is, the SS block number is indicated within the SS burst set through the TSS in each SS block, and the MSB among the SFNs may be included in the MIB payload at the time of the PBCH configuration in each SS block. The base station may transmit LSB (corresponding to 3 bits) and SS block location information (corresponding to 1 bit) in a frame by applying different scrambling sequences to each PBCH RV transmitted in 80 ms in 610 operation. Here, the RBCH RV may refer to the PBCH information in units of the SS burst set.

In this way, after setting the information on the SS burst set, the base station may transmit the SS burst set in the 620 operation (transmission may be performed by selecting one period value of 5, 10, 20, 40, 80, or 160 ms).

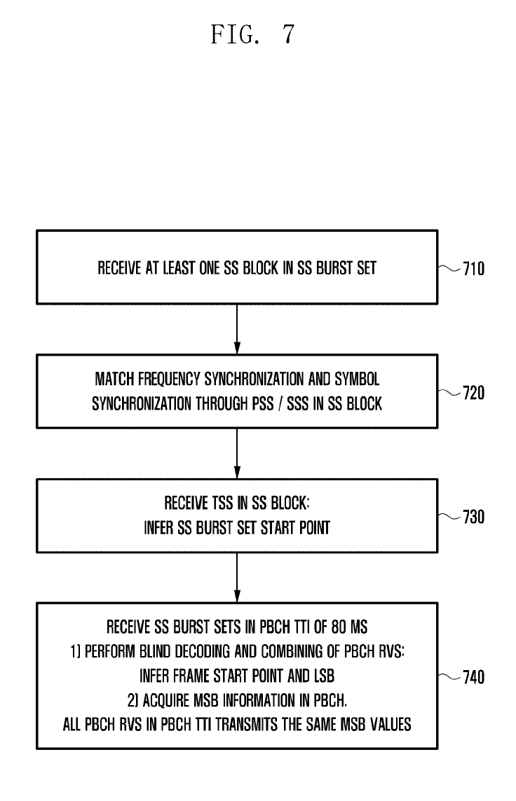

FIG. 7 shows a process of acquiring the slot start point, the SS burst set start point, the half-frame timing index, and the system frame number in the terminal through the method 1-1 and the method 2-1-1 according to an embodiment of the present disclosure.

Referring to FIG. 7, the terminal may receive at least one SS block in the SS burst in operation 710. Thereafter, the terminal may match frequency synchronization with symbol synchronization through the P_{SS}/SSS in the SS block in operation 720. In this way, after matching the frequency synchronization with the symbol synchronization, the terminal may receive the TSS in the SS block and infer the SS burst set start point in operation 730. This has been described above, and an additional explanation thereof will be omitted.

In addition, the terminal may also receive multiple SS burst sets in the PBCH TTI of 80 ms in operation 740. First, the blind decoding and combining of the PBCH RVs (SS burst sets) transmitted in the PBCH TTI may be performed to infer the half-frame timing index and the LSB. Thereafter, the terminal may obtain the PBCH MSB information using the received SS burst sets included in the PBCH TTI in operation 740. Since all the PBCH RVs in the PBCH TTI transmitted by the base station include the same MSB value, the terminal may acquire the MSB value using the above-described methods.

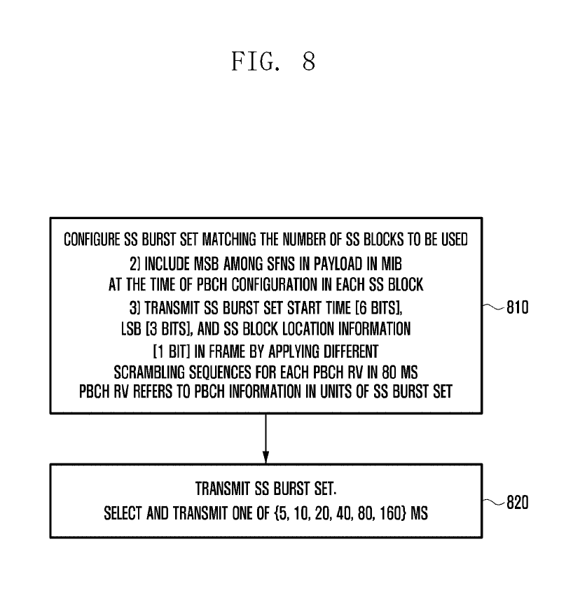

FIG. 8 shows an operation of transmitting a set of SS bursts from the base station through the method 3-1 according to an embodiment of the present disclosure.

Referring to FIG. 8, the base station may configure the SS burst set matching the number of SS blocks to be used in operation 810. In this case, the SS burst set may include the MSB among the SFN in the MIB payload at the time of the PBCH configuration in each SS block. In addition, the base station may apply different scrambling sequences to each PBCH RV transmitted in 80 ms in operation 810 to transmit the SS burst set start point (corresponding to 6 bits), the LSB (corresponding to 3 bits), and the SS block location information (corresponding to 1 bit) in the frame, and the PBCH RV may refer to the PBCH information in units of the SS burst set.

In this way, after setting the information on the SS burst set, the base station may transmit the SS burst set in the 820 operation (transmission may be performed by selecting one period value of 5, 10, 20, 40, 80, or 160 ms).

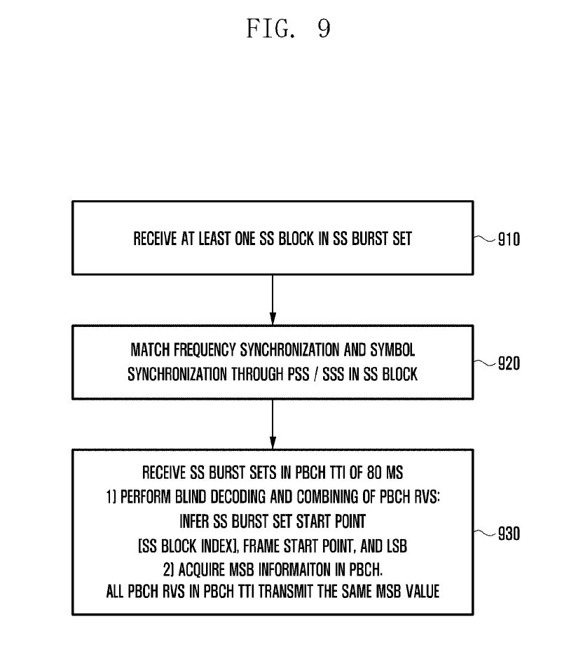

FIG. 9 shows a process of acquiring the slot start point, the SS burst set start point, the half-frame timing index, and the system frame number in the terminal through the method 3-1 according to an embodiment of the present disclosure.

Referring to FIG. 9, the terminal may receive at least one SS block in the SS burst in operation 910. Thereafter, the terminal may match frequency synchronization and symbol synchronization through the P_{SS}/SSS in the SS block in operation 920.

In addition, the terminal may also receive the SS burst sets in the PBCH TTI of 80 ms in operation 930. First, the blind decoding and combining of the PBCH RVs may be performed to infer the SS burst set start point (SS block index), the half-frame timing index, and the LSB. Thereafter, the terminal may acquire the MSB information in the PBCH in operation 930. Since all the PBCH RVs in the PBCH TTI transmitted by the base station transmit the same MSB value, the terminal may acquire the MSB value using the above-described methods.

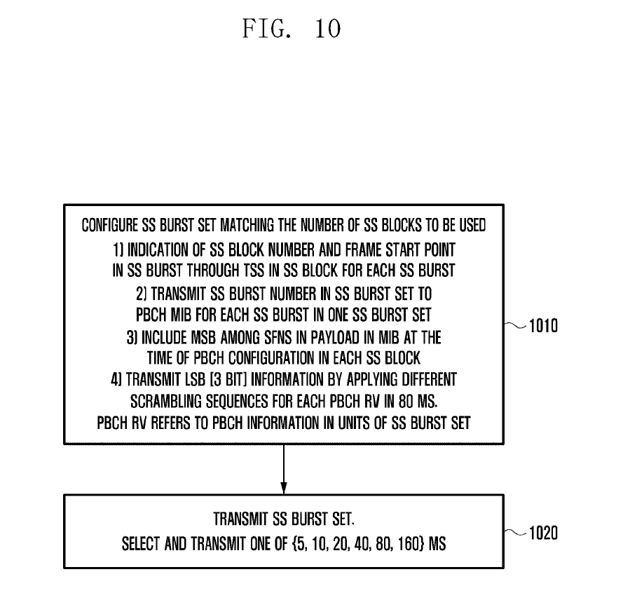

FIG. 10 shows an operation of transmitting the SS burst set from the base station when the method 1-5-1 and the method 2-2 according to an embodiment of the present disclosure are combined.

The base station may configure the SS burst set matching the number of SS blocks to be used in operation 1010. The configuration of the SS burst set may be configured to indicate the SS block number in the SS burst and the half-frame timing index information through the TSS in each SS block. In addition, the base station can also be configured to transmit the SS burst number within the SS burst set to the PBCH MIB for each SS burst in one SS burst set when configuring the SS burst set. In addition, the base station can include the MSB and the SS burst number in SS burst set in the MIB payload at the time of the PBCH configuration in each SS block. In addition, the base station may apply different scrambling sequences to each PBCH RV transmitted in 80 ms when configuring the SS burst set to transmit the LSB (corresponding to 3 bits). Here, the RBCH RV may refer to the PBCH information in units of the SS burst set.

In this way, after setting the information on the SS burst set, the base station may transmit the SS burst set in the 1020 operation (transmission may be performed by selecting one period value of 5, 10, 20, 40, 80, or 160 ms).

In particular, in order to transmit the half-frame timing index information and the SS block number in the SS burst through the TSS, for example, if the SS burst set consists of 64 SS blocks and one SS burst includes 4 SS blocks, the base station in which the actual SS burst set transmission period is 5 ms may transmit sequences Nos. 1/2/3/4 to TSSs transmitted through 4 SS blocks in the SS burst included in the SS burst transmitted at locations of 0/10/20/30/40/50/60/70 ms in the PBCH TTI. In addition, sequences Nos. 5/6/7/8 may be transmitted to the TSSs transmitted through the 4 SS blocks in the SS burst including the SS burst transmitted at locations of 5/15/25/35/45/55/65/75 ms. By checking to which sequence the TSS was transmitted, the terminal can infer the SS start point (half-radio frame timing) and the SS block index in the SS burst. Alternatively, the base station in which the actual SS burst set transmission period is 20 ms may transmit sequences 1/2/3/4 to the TSSs transmitted through the 4 SS blocks in the SS burst included in the SS burst transmitted at locations of 0/20/40/60 ms in the PBCH TTI.

Also, for LSB information transmission, the base station in which the actual SS burst set transmission period is 5 ms may sequentially apply scrambling sequences Nos. 1/1/2/2/3/3/4/4/5/5/6/6/7/7/8/8 to information bits configuring the PBCH RVs transmitted at locations of 0/5/10/15/20/25/30/35/40/45/50/55/60/65/70/75 ms in the PBCH TTI. On the other hand, the base station in which the actual SS burst set transmission period is 20 ms may sequentially apply scrambling sequences Nos. 1/3/5/7 to information bits configuring the PBCH RVs transmitted at locations of 0/20/40/60 ms.

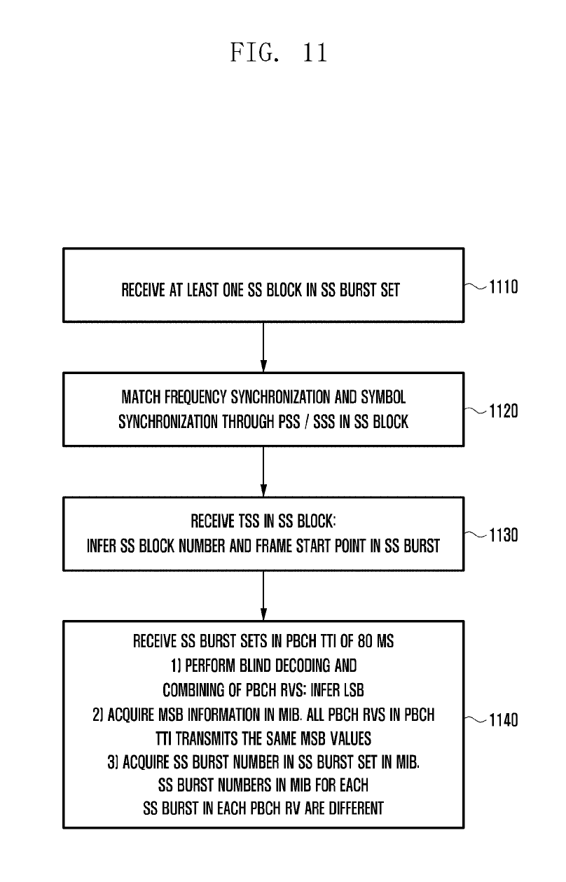

FIG. 11 shows a process of acquiring the slot start point, the SS burst set start point, the half-frame timing index, and the system frame number in the terminal through the method 1-5-1 and the method 2-2 according to an embodiment of the present disclosure.

Referring to FIG. 11, the terminal may receive at least one SS block in the SS burst in operation 1110. Thereafter, the terminal may match frequency synchronization and symbol synchronization through the P_{SS}/SSS in the SS block in operation 1120. After receiving the TSS in the SS block after the frequency synchronization and the symbol synchronization match each other, the terminal may infer the SS block number and the half-frame timing index in the SS burst in operation 1130. This has been described above, and an additional explanation thereof will be omitted.

In addition, the terminal may also receive multiple SS burst sets in the PBCH TTI of 80 ms in operation 1140. Describing in more detail, the terminal may perform the blind decoding and combining of the PBCH RVs (SS burst sets) transmitted in the PBCH TTI to infer the LSB. Thereafter, the terminal may obtain the PBCH MSB information using the received SS burst sets included in the PBCH TTI. Since all the PBCH RVs in the PBCH TTIs transmitted by the base station include the same MSB value, but the MIB information for each SS block in one PBCH RV may be different, the blind decoding may be involved to completely obtain the MIB information by combining multiple SS blocks. In addition, the terminal can obtain the SS burst number information in the MIB for each SS burst within the SS burst set. In this case, since the MIB information for each SS block transmitted in one SS burst set may be different, the blind decoding may be involved to completely obtain the MIB information by combining multiple SS blocks.

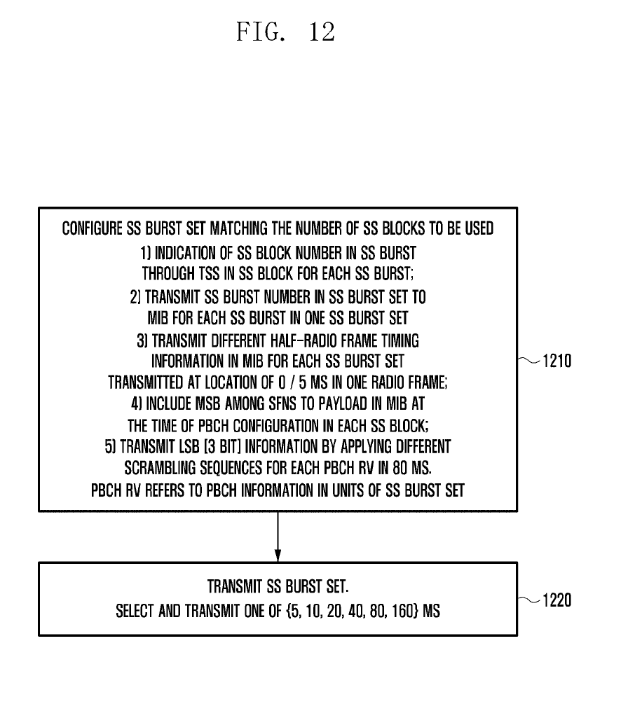

FIG. 12 shows an operation of transmitting the SS burst set from the base station when the method 1-5-1 and the method 2-10 according to an embodiment of the present disclosure are combined.

The base station may configure the SS burst set matching the number of SS blocks to be used in operation 1210. In more detail, the base station can be configured to indicate the SS block number in the SS burst through the TSS in each SS block and transmit the SS burst number within the SS burst set to the MIB for each SS burst in one SS burst set. In addition, the base station may be configured to transmit different half-radio frame timing information in the MIB for each SS burst set transmitted at locations of 0 ms or 5 ms in one radio frame. Thereafter, the base station may include the SS burst number within the SS burst set and the half-frame timing index information in the MIB payload at the time of the PBCH configuration in each SS block. In addition, the base station may apply different scrambling sequences to each PBCH RV transmitted in 80 ms when configuring the SS burst set to transmit the LSB (corresponding to 3 bits). Here, the RBCH RV may refer to the PBCH information in units of the SS burst set.

In this way, after setting the information on the SS burst set, the base station may transmit the SS burst set in the 1220 operation (transmission may be performed by selecting one period value of 5, 10, 20, 40, 80, or 160 ms).

In particular, in order to transmit the SS block number in the SS burst through the TSS, for example, if the SS burst set consists of 64 SS blocks, and one SS burst includes 4 SS blocks, sequences Nos. 1/2/3/4 may be transmitted to the TSSs transmitted through the 4 SS blocks in the SS burst. By checking to which sequence the TSS was transmitted, the terminal can infer the SS block index in the SS burst.

Also, for LSB information transmission, the base station in which the actual SS burst set transmission period is 5 ms may sequentially apply scrambling sequences Nos. 1/1/2/2/3/3/4/4/5/5/6/6/7/7/8/8 to information bits configuring the PBCH RVs transmitted at locations of 0/5/10/15/20/25/30/35/40/45/50/55/60/65/70/75 ms in the PBCH TTI. On the other hand, the base station in which the actual SS burst set transmission period is 20 ms may sequentially apply scrambling sequences Nos. 1/3/5/7 to information bits configuring the PBCH RVs transmitted at locations of 0/20/40/60 ms.

To transmit the SS burst index information in the SS burst set in the MIB, the PBCHs transmitted through the 16 SS bursts in the SS burst set are sequentially transmitted with numbers from 0 to 15. In addition, in order to transmit the half-frame timing index information in the MIB, the base station in which the actual SS burst set transmission period is 5 ms may transmit 0 to the MIB of the PBCH RVs transmitted at locations of 0/10/20/30/40/50/60/70 ms, and transmit 1 to the MIB of the PBCH RVs transmitted at locations of 5/15/25/35/45/55/65/75 ms.

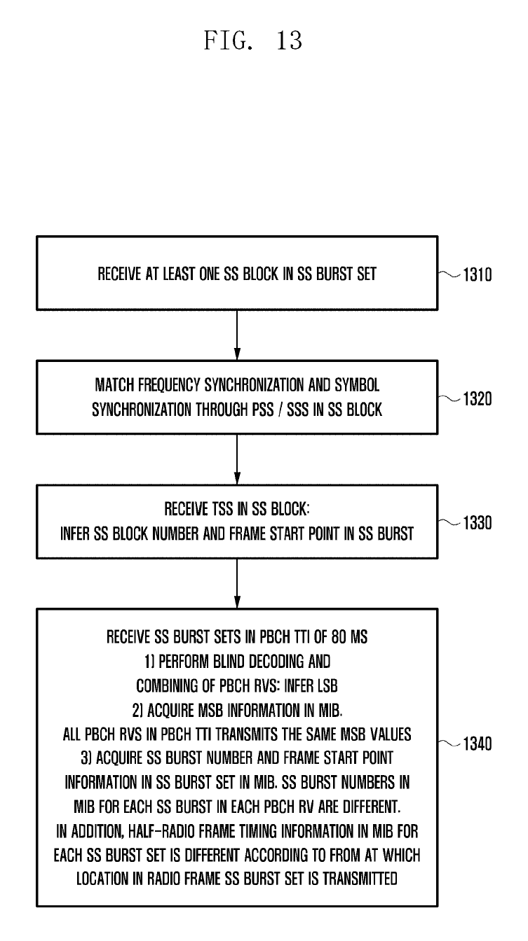

FIG. 13 shows a process of acquiring the slot start point, the SS burst set start point, the half-frame timing index, and the system frame number in the terminal through the method 1-5-1 and the method 2-10 according to an embodiment of the present disclosure.

Referring to FIG. 13, the terminal may receive at least one SS block in the SS burst in operation 1310. Thereafter, the terminal may match frequency synchronization and symbol synchronization through the P_{SS}/SSS in the SS block in operation 1320. In this way, after matching the frequency synchronization with the symbol synchronization, the terminal may receive the TSS in the SS block and infer the SS block number in operation 1330. This has been described above, and an additional explanation thereof will be omitted.

In addition, the terminal may also receive multiple SS burst sets in the PBCH TTI of 80 ms in operation 1340. This will be described in more detail. First, the terminal may perform the blind decoding and combining of the PBCH RVs (SS burst sets) transmitted in the PBCH TTI to infer the LSB. Thereafter, the terminal may obtain the PBCH MSB information using the received SS burst sets included in the PBCH TTI. Since all the PBCH RVs in the PBCH TTIs transmitted by the base station include the same MSB value, but the MIB information for each SS block in one PBCH RV may be different, the blind decoding may be involved to completely obtain the MIB information by combining multiple SS blocks. In addition, the terminal can obtain the SS burst number information in the MIB for each SS burst in the SS burst set. In this case, since the MIB information for each SS block transmitted in one SS burst set may be different, the blind decoding may be involved to completely obtain the MIB information by combining multiple SS blocks. In addition, the terminal may also obtain different half-radio frame timing information in the MIB depending on which of 0 ms and 5 ms in the radio frame the SS burst set is located. In this case, since the MIB information for each SS block included in each SS burst set may be different, the blind decoding may be involved to completely obtain the MIB information by combining multiple SS blocks.

<Operation According to Status of Terminal>

As described above, the terminal may differently recognize the transmission period of the SS burst set according to a state (i.e., initial access state, CONNECTED state, IDLE state) of the terminal and an operating frequency. For example, the terminal wanting to perform the initial cell selection regardless of the frequency band may recognize the transmission period of the SS burst set as 20 ms.

In addition, for the CONNECTED state terminal, the base station may configure the SS burst set period different from the period which the initial access terminal recognizes. Thereafter, the terminal may receive the SS burst set according to the SS burst set period that the base station configures. As the SS burst set period values that the base station may configure, 5, 10, 20, 40, 80, 160 ms, and the like may be used.

In addition, the IDLE terminal may use the configured SS burst set period as it is when being connected to the network as needed, or may receive the SS burst set based on the same SS burst set period as an initial access user.

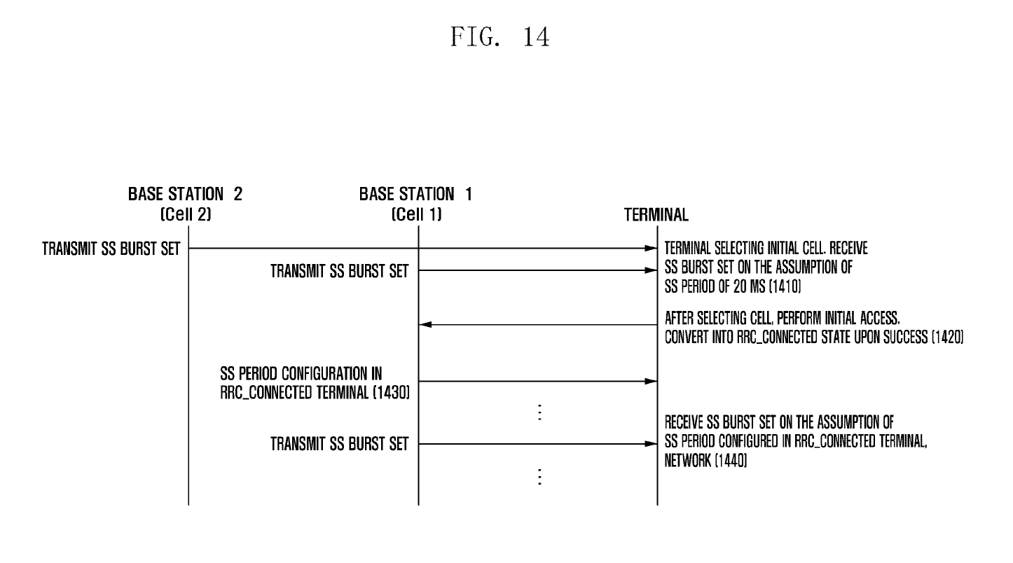

FIG. 14 is a diagram illustrating the SS burst set receiving operation and a base station operation for an initial cell selection terminal and an RRC_CONNECTED state terminal according to an embodiment of the present disclosure.

In particular, FIG. 14 shows an embodiment in which there are two cells (Cell or base station) and the terminal is initially connected to the first cell (Cell 1 or BS 1) to be CONNECTION. Here, the base station is a gNB, and may include a single or multiple TRPs. According to an embodiment of the present disclosure, the terminal receives the SS burst set from the cells in the initial cell selection (SS cycle=SS burst set cycle) on the assumption that the set is transmitted at a period of 20 ms (1410). The SS burst set may include an RS for decoding the P_{SS}/SSS/PBCH/PBCH. After the cell is selected, the terminal performs an initial access and is switched to the RRC_CONNECTED state at the time of the initial access success (1420). The serving cell base station may configure a period of an SS burst set different from the period recognized by the initial cell selecting terminal in of the RRC_CONNECTED state terminal, and this value may be selected from {5, 10, 20, 40, 80, 160 ms} (1430). The SS burst set period (also referred to as the SS period) may be transmitted via the MIB, cell-specific RRC signaling, UE-specific RRC signaling, and the like. The corresponding SS period may be a value only for the RRC_CONNECTED user or a value for all the RRC_CONNECTED/RRC_IDLE users. After that, if the terminal is in the RRC_CONNECTED state, it receives the SS burst set according to the SS period configured by the base station (1440). If a serving cell base station does not perform a special indication through higher layer signaling, it may assume that the SS period is transmitted every 5 ms.

The RRC_CONNECTED terminal does not need to continuously decode the PBCH after decoding the PBCH initially. However, when it recognizes that the system information (SI) has been changed from the paging message transmitted by the base station, the terminal may perform the decoding on the PBCH to acquire the changed system information. At this time, the operations of the base station/terminal may be operated by one of the following:

Alt 1. The base station may indicate one SS period value through higher layer signaling for the RRC_CONNECTED/RRC_IDLE user. If the SS period information that the terminal has previously indicated from higher layer signaling exceeds 20 ms, the terminal may perform the PBCH decoding to obtain the changed system information, on the assumption that an SS period is 20 ms assumed in the initial cell selection. For example, in the case of receiving information indicating that the system information has been updated from the paging message is received even though it is instructed to assume the SS period of 80 ms by higher layer signaling, the SS burst set of 20 ms is assumed for the decoding of the updated system information.

Alt 2. The terminal may receive the SS period information that should be assumed when the system information is changed from higher layer signaling. The terminal may assume the SS period receiving the indication which should be assumed when the system information is changed for decoding the updated system information.

Alt 3. When the terminal does not receive the SS period information from the higher layer signaling, the terminal may perform the PBCH decoding on the assumption that the SS period is 5 ms.

Alt 4. The base station may indicate one SS period value through higher layer signaling for the RRC_CONNECTED/RRC_IDLE user. If the SS period information that the terminal has previously indicated from higher layer signaling does not exceed 20 ms, the terminal may perform the PBCH decoding to obtain the changed system information based on the indicated SS period information.

Alt 5. The base station may indicate one SS period value through higher layer signaling for the RRC_CONNECTED/RRC_IDLE user. Regardless of the SS period value that the terminal has received from higher layer signaling, the terminal may assume the SS period of 20 ms that was assumed at the time of the initial cell selection to decode the updated PBCH.

Alt 6. The base station may indicate one SS period value through higher layer signaling for the RRC_CONNECTED/RRC_IDLE user. In addition to the message indicating whether the system information is changed in the paging message, the base station may include the SS period information which should be assumed when decoding the changed system information. When the corresponding messages are received through the paging message, the PBCH decoding is performed based on the SS period configured in the paging message to obtain updated system information. For example, even if it is instructed to assume the SS period of 80 ms through the higher layer signaling, if the terminal is instructed to assume the SS period of 20 ms from the paging message when decoding update system information, the terminal assumes 20 ms for the updated system information decoding.

Alt 7. The base station may indicate one SS period value through higher layer signaling for the RRC_CONNECTED/RRC_IDLE user. If the base station may include the SS period information which should be assumed when the terminal decodes the changed system information together with a message informing whether or not to change the system information, when the SS period information which should be assumed at the time of decoding the specially changed system information is not included in the paging message, the terminal can perform the updated system information decoding based on the SS period indicated through the higher layer signaling.

Alt 8. If the base station may include the SS period information which should be assumed when the terminal decodes the changed system information together with a message informing whether or not to change the system information, when the SS period information which should be assumed at the time of decoding the specially changed system information is not included in the paging message and the terminal does not have the specially indicated SS period through the higher layer signaling, the terminal can perform the updated system information decoding based on 5 ms.

The RRC_CONNECTED terminal should perform L3 measurement on the neighboring cell before performing handover (HO). By reporting this measurement value to the base station, the handover may be performed if necessary. It may not be necessary to read the PBCH for the neighboring cell measurement to be performed before the handover. However, when it is necessary to know the time information (e.g., SS burst set start point, half-frame timing index, system frame number, or the like) of neighboring cells through the PBCH decoding, a process of decoding the neighboring cell PBCH is used. For example, if the CSI-RS of the neighboring cell is used for the L3 measurement, the time information of the neighboring cells is needed to find the accurate location of the CSI-RS of the neighboring cell. If the system frame number of the neighboring cell can be inferred (for example, in the case of LTE, the synchronization signal transmitted from a plurality of cells is transmitted within a predetermined time), when the SS burst set start point information and the half-frame timing index information are possible without performing the PBCH decoding, the operation described in the embodiment may not be performed. When the PBCH decoding is used for the terminal to measure the neighboring cell performed before the handover, the operations of the base station/terminal can be operated in one of the following.

Alt 1. The base station may indicate one SS period value through higher layer signaling for the RRC_CONNECTED/RRC_IDLE user. If the SS period information that the terminal has previously indicated from higher layer signaling exceeds 20 ms, the terminal may perform the neighboring cell PBCH decoding on the assumption that the SS period is 20 ms assumed at the time of the initial cell selection. For example, even if it is instructed to assume the SS period of 80 ms by higher layer signaling, it assumes the SS burst set period of 20 ms at the time of the neighboring cell PBCH decoding.

Alt 2. The base station may indicate one SS period value through higher layer signaling for the RRC_CONNECTED/RRC_IDLE user. When the terminal does not receive the SS period information from the higher layer signaling, the terminal may perform the neighboring cell PBCH decoding on the assumption that the SS period is 5 ms.

Alt 3. The base station may indicate one SS period value through higher layer signaling for the RRC_CONNECTED/RRC_IDLE user. If the SS period information that the terminal has previously indicated from higher layer signaling does not exceed 20 ms, the terminal may perform the neighboring cell PBCH decoding to obtain the changed system information based on the indicated SS period information.

Alt 4. The base station may indicate one SS period value through higher layer signaling for the RRC_CONNECTED/RRC_IDLE user. Regardless of the SS period value that the terminal has received from higher layer signaling, the terminal may assume the SS period of 20 ms that was assumed at the time of the initial cell selection to decode the neighboring cell PBCH.

Alt 5. The base station may indicate the SS period information which should be assumed when decoding the neighboring cell PBCH from higher layer signaling. At this time, the terminal may assume the SS period indicated for the PBCH decoding of the neighboring cell.

The base station may include a message informing whether or not to change the system information. The operations of the base station/terminal associated with the paging message that the RRC_IDLE terminal receives may be defined as one of the following.

Alt 1. The base station may indicate one SS period value through higher layer signaling for the RRC_CONNECTED/RRC_IDLE user. In the RRC_IDLE state, if it is recognized that the system information has been updated through the paging message and the SS period value indicated through the higher layer signaling exceeds 20 ms, the terminal may perform the PBCH decoding on the assumption that the SS period value assumed at the time of automatically selecting the initial cell to obtain the changed system information.

Alt 2. The base station may indicate the SS period where the RRC_IDLE user should assume at the time of changing the system information through the higher layer signaling, and the terminal may perform the PBCH decoding to obtain the system information in which the corresponding SS period value is updated.

Alt 3. The base station may indicate one SS period value through higher layer signaling for the RRC_CONNECTED/RRC_IDLE user. If it is recognized that the system information has been updated through the paging message regardless of the SS period value indicated through the higher layer signaling, the terminal may perform the PBCH decoding on the assumption that the SS period value assumed at the time of selecting the initial cell is 20 ms to obtain the changed system information.

Alt 4. The base station may indicate one SS period value through higher layer signaling for the RRC_CONNECTED/RRC_IDLE user. If it is recognized that the system information has been updated through the paging message regardless of the SS period value indicated through the higher layer signaling, the terminal may perform the PBCH decoding on the assumption that the SS period value assumed at the time of selecting the initial cell is 20 ms to obtain the changed system information.

Alt 5. If the terminal does not receive the indication of the SS period value through the higher layer signaling, the terminal may perform the PBCH decoding to obtain the updated system information on the assumption that the SS period is 5 ms.

Alt 5. The base station indicates the SS period value on the assumption that the user should be assumed in the IDLE state by through higher layer signaling. This may differ from the value assumed by the RRC_CONNECTED user. The terminal performs the SS burst set reception based on the corresponding value in the IDLE state.

Alt 6. In addition to the message indicating whether the system information is changed in the paging message, the base station may include the SS period information which should be assumed when decoding the changed system information. When the corresponding messages are received through the paging message, the PBCH decoding is performed based on the SS period configured in the paging message to obtain updated system information. For example, even if it is instructed to assume the SS period of 80 ms through the higher layer signaling, if the terminal is instructed to assume the SS period of 20 ms from the paging message when decoding update system information, the terminal assumes 20 ms for the updated system information decoding.

Alt 7. The base station may indicate one SS period value through higher layer signaling for the RRC_CONNECTED/RRC_IDLE user. If the SS period information which should be assumed at the time of decoding the specially changed system information is not included in the paging message, the terminal can decode the updated system information based on the SS period indicated through the higher layer signaling.

Alt 8. If the SS period information which should be assumed at the time of decoding the specially changed system information is not included in the paging message and the terminal does not have the SS period specially indicated through the higher layer signaling, the terminal can perform the updated system information decoding based on 5 ms.

The RRC_IDLE terminal may perform cell-reselection when it wakes up to receive a paging message for itself. When the RRC_IDLE terminal performs the cell-reselection, the operation of reading the system information about the re-selected cell is used. One of the reasons is to identify whether the corresponding cell is the same tracking area. The operations of the base station/terminal associated with the cell-reselection may be defined as follows.

Alt 1. The base station may indicate one SS period value through higher layer signaling for the RRC_CONNECTED/RRC_IDLE user. If the SS period value indicated through the higher layer signaling in the RRC_CONN state exceeds 20 ms, the terminal in the RRC_IDLE state may decode the PBCH decoding on the assumption that the SS period value assumed at the time of automatically selecting the initial cell is 20 ms to obtain the system information while performing the cell-reselection.

Alt 2. The base station may indicate to an RRC_CONN terminal the SS period which should be assumed at the time of the cell-reselection through the higher layer signaling, and the terminal may apply the corresponding SS period value to obtain the system information at the time of the cell-reselection.

Alt 3. The base station may indicate one SS period value through higher layer signaling for the RRC_CONNECTED/RRC_IDLE user. The terminal may perform the system information decoding in the RRC-CONN state on the assumption that the SS period value assumed at the time of selecting the initial cell is 20 ms to obtain the cell-reselected system information regardless of the SS period value indicated through the higher layer signaling.

Alt 4. The base station may indicate one SS period value through higher layer signaling for the RRC_CONNECTED/RRC_IDLE user. If it is recognized that the system information has been updated through the paging message regardless of the SS period value indicated through the higher layer signaling in the RRC_CONN state, the terminal may perform the PBCH decoding on the assumption that the SS period value assumed at the time of selecting the initial cell is 20 ms to obtain the changed system information.

Alt 5. If the terminal does not receive the indication of the SS period value through the higher layer signaling in the RRC_CONN state, the terminal may continuously perform the decoding to obtain the updated system information on the assumption that the SS period is 5 ms.

Alt 6. The base station indicates the SS period value on the assumption that the user should be assumed in the IDLE state by through higher layer signaling. This may differ from the value assumed by the RRC_CONNECTED user. The terminal performs the SS burst set reception based on the corresponding value in the IDLE state.

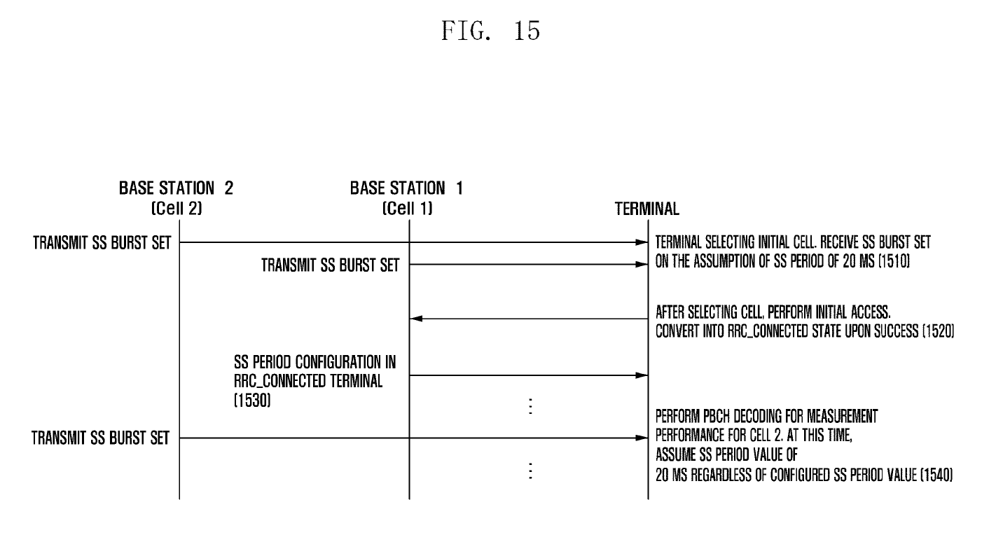

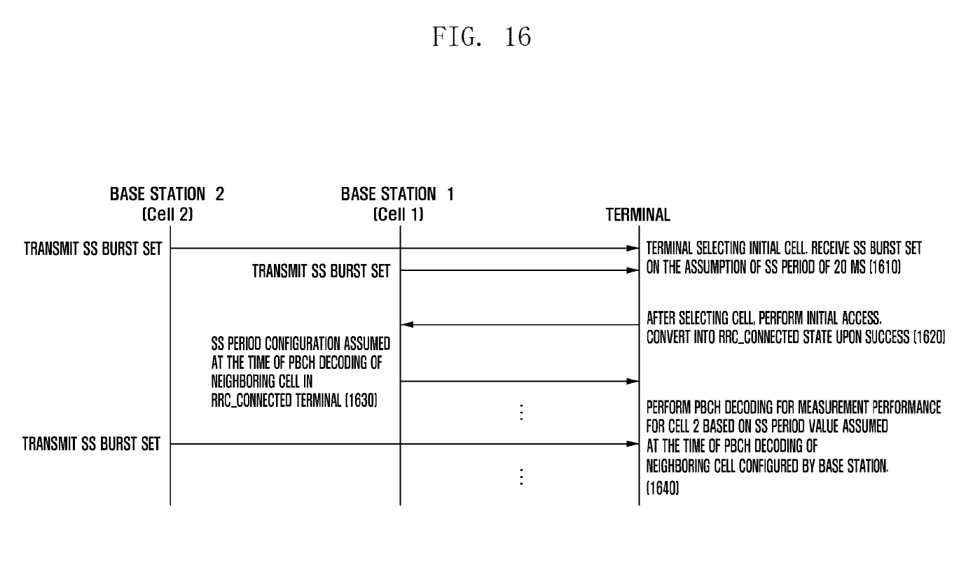

The operations Alt. 4 and Alt. 5 of the base station/terminal associated with the handover (HO) performance of the RRC_CONNECTED terminal are illustrated in FIGS. 15 and 16, respectively. Alt 4 is a case where the SS period assumed by the terminal to decode the neighboring cell PBCH is 20 ms even if the base station indicates a specific SS period value through higher layer signaling. Alt 5 indicates the SS period information to be assumed when the base station decodes the neighboring cell PBCH from the higher layer signaling, and the terminal receives and decodes the neighboring cell PBCH on the assumption of the indicated SS period.

FIG. 15 is a diagram illustrating Alt 4 among the SS burst set receiving operation and the base station operation in neighbor cell PBCH decoding before the RRC-CONNECTED state terminal performs HO according to an embodiment of the present disclosure.

Although only two cells are represented in FIG. 15, there may actually be more cells. The terminal establishes a connection with cell 1 through cell selection at the time of the initial connection. Thereafter, the terminal enters the RRC_CONNECTED state, and the base station indicates the SS period to be assumed by the terminal through the higher layer signaling to the terminal. The SS period value may refer to a value which should be commonly assumed when the terminal is in the RRC_CONNECTED state and the RRC_IDLE state. Thereafter, the terminal may have to decode the neighboring cell PBCH to collect the information used for performing measurements on neighboring cells before HO.

FIG. 16 is a diagram illustrating Alt 5 among the SS burst set receiving operation and the base station operation in neighbor cell PBCH decoding before the RRC-CONNECTED state terminal performs HO according to an embodiment of the present disclosure; Although only two cells are represented in FIG. 16, there may actually be more cells. The terminal establishes a connection with cell 1 through cell selection at the time of the initial connection. Thereafter, the terminal is in the RRC_CONNECTED state, and the base station indicates to the present terminal the SS period which should be assumed at the time of decoding the neighboring cell PBCH to collect information used for performing measurements on the neighboring cells before the HO through the higher layer signaling. Thereafter, the terminal may assume the SS period value indicated by the base station through the higher layer signaling at the time of receiving and decoding the neighboring cell PBCH to collect information used for the measurement on neighboring cells before HO.

<SS Block Time Axis Mapping Method and Operations of Base Station and Terminal>

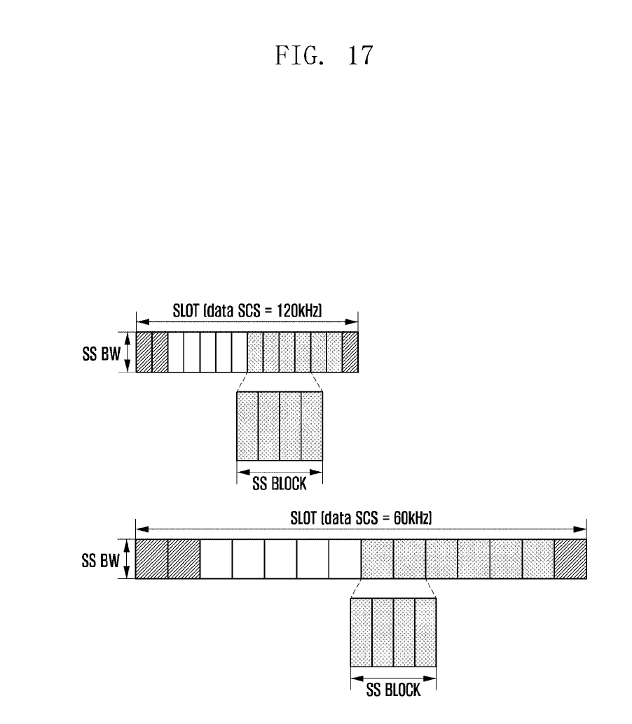

As described in FIG. 5, the transmission position of the SS slot and the SS block is not defined based on the sub carrier spacing (SS SCS), and a method for transmitting the SS block in the OFDM symbol of the fixed location in the slot determined based on the data SCS is possible. If the SS SCS is fixed, the time duration used to transmit the SS block is fixed, and the number of SS blocks in the slot defined according to the data SCS may be different. An example of the SS block mapping when data SCS is 120 kHz and data SCS is 60 kHz is shown in FIG. 17.

At this time, describing the case of FIG. 17 by way of example, it can be seen that a part of the second SS block transmitted in the slot of the SS block may not be transmitted in the same slot. The remaining SS blocks will be transmitted through #7 to #8 OFDM symbols of the next slot. At this time, if the PBCH is located on both sides of the SS block according to the structure of the SS block, the terminal should know that some SS blocks are transmitted over two slots for decoding the PBCH. In order to find this, a method of indicating data SCS information using a synchronous signal is possible, and TSS may be used therefor. For example, if the data SCS allowed in the 6 GHz system are three types of 60 kHz, 120 kHz, and 240 kHz, the value of the data SCS may be directly transmitted when the TSS is a message type, and if the TSS is a sequence type, a root index may be different.

<SS Block Configuration>

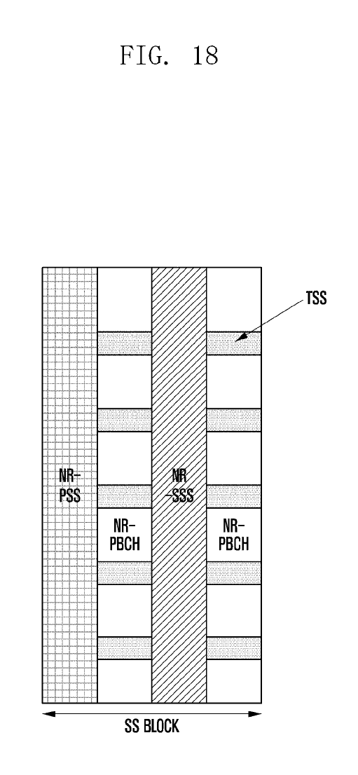

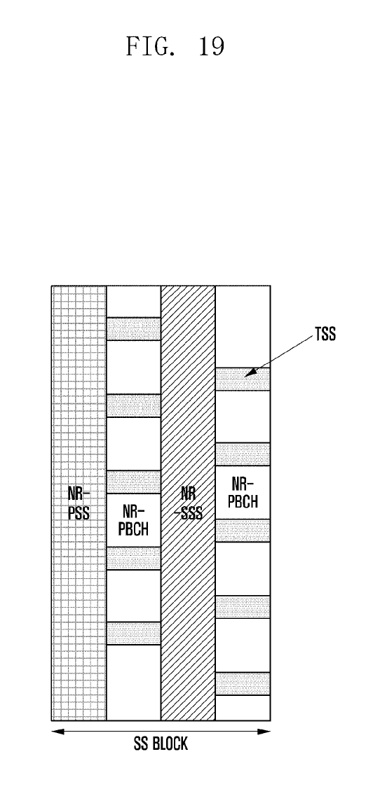

In the present disclosure, it is proposed that the SS block includes P_{SS}, SSS, TSS, and PBCH as an example. FIGS. 18 and 19 show a case where the TSS is transmitted at equal intervals in the middle of the NR-PBCH.

In FIGS. 18 and 19, the order of symbols including P_{SS}, SSS, PBCH+TSS is irrelevant. The big difference between FIGS. 18 and 19 is that the TSS location in the OFDM symbol including the first and second PBCH+TSS and the PBCH value mapped to RE are different. For example, suppose that the SS block consists of 24 RBs (REs Nos. 0 to 287) on the frequency axis. In FIG. 18, if the TSS is transmitted in REs Nos. 9, 109, and 209 of the OFDM symbol including two PBCH+TSSs, then in FIG. 19, when the TSS is allocated to REs Nos. 9, 109, and 209 of the OFDM symbols including the first PBCH+TSS, the TSS can be transmitted REs Nos. 59, 159, and 259 of the OFDM symbol including the second PBCH+TSS. At this time, a shift amount of the TSS location of the OFDM symbol including two PBCH+TSS is referred to as □shift. In the above description, □shift=50. In this case, if the payload of the PBCH transmitted in one SS block is Kbit and the code rate is Q, in the case of FIG. 18, the PBCH data transmitted in REs Nos. 0 to 287 other than the TSS transmission location of the OFDM including the respective PBCH+TSS may be represented by the following <Equation 17>, and the corresponding data are sequentially mapped to the REs other than the TSS.

\tilde{b}(i)=(b(i)+c(i))mod 2 [Equation 17]

In the above Equation 17, b represents the information bit block after k_{bit} is encoded at a code rate of 2×Q, and c is the scrambling sequence applied to the corresponding block.

In FIG. 19, in the case of the OFDM symbol including the first PBCH+TSS, the PBCH data may be configured by the above <Equation 17>, and in the case of the OFDM symbol including the second PBCH+TSS, the PBCH data should be configured by the following <Equation 18>.

\tilde{b}(i)=(b^{m}(i)+c^{m}(i))mod 2 [Equation 18]

In above Equation 18, b^{m}(i)=b((i+Δ_{shift})mod L), c^{m}(i)=c((i+Δshift) mod L), i=0, . . . , L−1. b represents an information bit block after encoding k_{bit} at a code rate of 2×Q, and L is a length of b and c, and the corresponding example represents 288.

In this way, when the PBCH is designed, it is possible to estimate CFO using the TSS and PBCH reception value in two OFDM symbols.

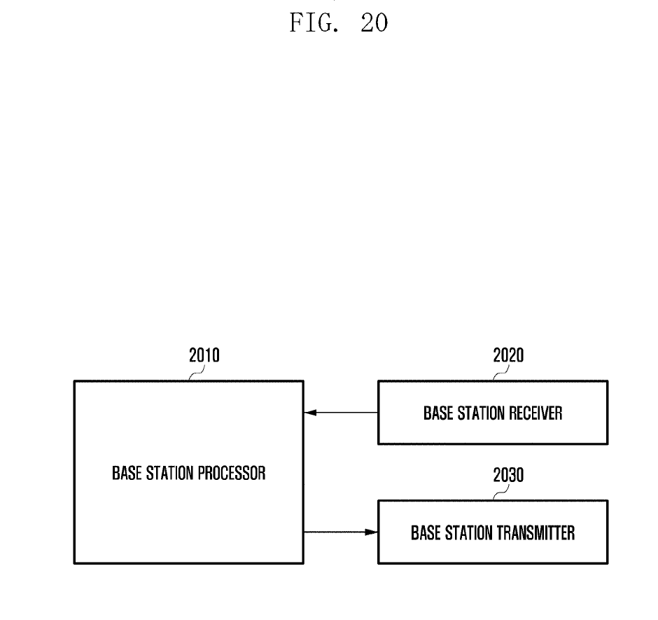

FIG. 20 illustrates a functional block diagram of a base station apparatus according to the present disclosure.

The functional operations of the base station according to the present disclosure will be described with reference to FIG. 20. Referring to FIG. 20, the base station may include a base station processor 2010, a base station receiver 2020, and a base station transmitter 2030. The base station processor 2010 may encode and modulate data to be transmitted and map a reference signal according to the present disclosure together with data or separate from data to a desired position and output the same to the base station transmitter 2030. Therefore, each of the signals described above may be modulated, processed and output according to the present disclosure. The base station receiver 2020 low-noise amplifies and down-converts the signal received from the antenna into a baseband signal and outputs the converted signal. The data processor 2010 may also demodulate and decode the baseband signal received in the radio signal processor 2010 and provide the demodulated and decoded signal to the base station transmitter 2030. The base station transmitter 2030 may up-convert and amplify a signal into a frequency band that operates in the system, and transmit the signal to the terminal through one or more antennas. It should be noted that the block diagram of the base station of FIG. 20 shown in this disclosure does not impose any particular restriction on this aspect of the configuration, but is a block configuration in terms of functionality only.

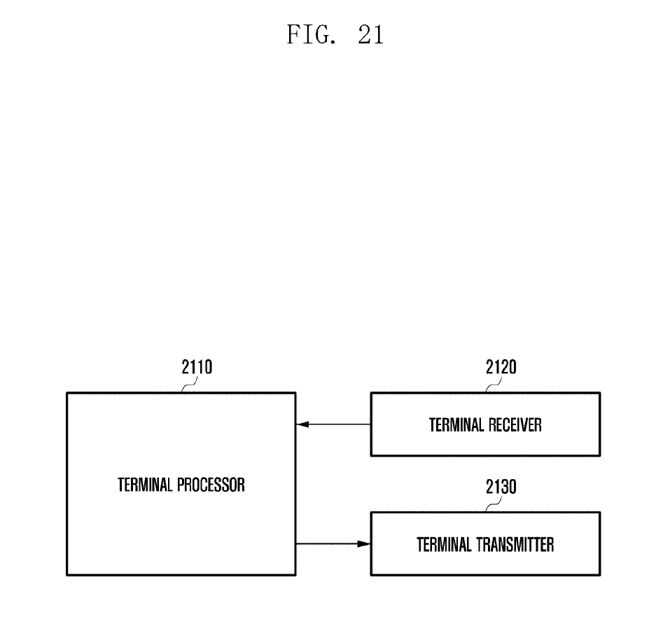

FIG. 21 illustrates a functional block diagram of a terminal apparatus according to the present disclosure.

Referring to FIG. 21, the terminal device may include a terminal processor 2110, a terminal receiver 2120, and a terminal transmitter 2130. The terminal processor 2110 can perform an overall operation for signal reception according to the present disclosure. In particular, the terminal processor 2110 can appropriately control the operation according to the state of the terminal as described above. The terminal receiver 2120 receives the above-described signals through a preset band, and band-down-converts and output the signals. The terminal transmitter 2130 may transmit signals to be transmitted to the base station. In FIG. 21, it should be noted that only the configuration necessary for explaining the present disclosure is illustrated, and the other configurations are omitted.

Next, a logical structure for signaling the SS block index according to the present disclosure will be described.

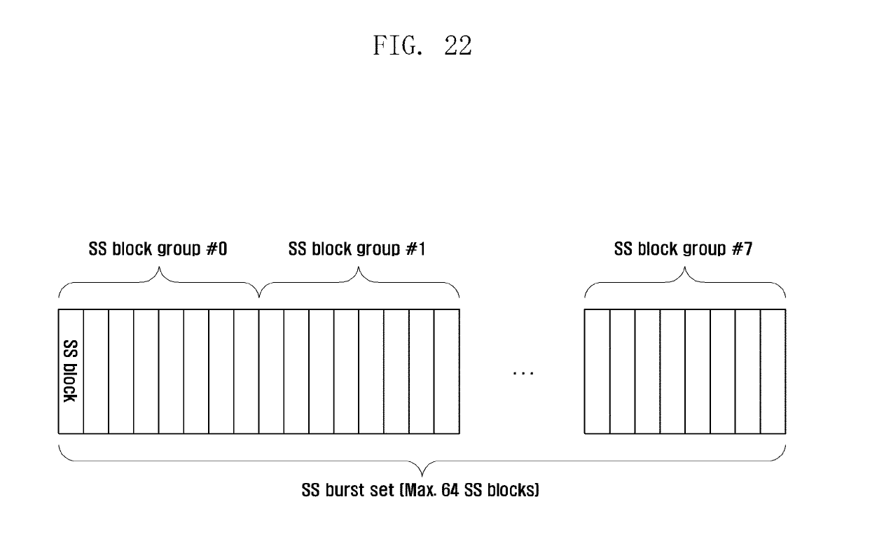

FIG. 22 is a diagram illustrating a logical structure for signaling an SS block index according to the present disclosure.

Prior to referring to FIG. 22, the need for a scheme in accordance with the present disclosure will be discussed. The UE in the CONNECTED state should receive the information on the neighboring target cell during the handover and may receive the HO command or the RRC reconfiguration message. In this case, the terminal may perform the handover without decoding the PBCH of the neighboring target cell. However, a timing index, for example, a system frame number (SFN), a half frame index, and an SS block index should be transmitted in a different manner due to uncertainty of a transmission time point. It is necessary for the terminal to acquire the timing index of the neighboring cell including the target cell without the PBCH decoding.

Accordingly, the present disclosure provides a method of transmitting partial information of a SS block index to DMRS of PBCH, a method of indicating whether a base station synchronizes with surrounding cells, and a method of assuming, by a terminal, an inter-cell synchronization within a certain value.

The system for applying FIG. 22 will be described on the assumption of the following system structure. The frame is in units of 10 ms, and the half frame is 5 ms. The maximum number of SS signal blocks in the synchronization signal SS burst set may be one of 4, 8, and 64 and may vary depending on the frequency band or the subcarrier spacing (SCS) of the SS block.

The SS block index may have up to 6 bits and may be mapped to the SS block sequence in the following manner. The reason for this mapping is to allow the terminal to know the SS block index of the target cell only by the DMRS of the PBCH without PBCH decoding.

(1) When the maximum number of SS blocks is 4: The SS block index is indicated through LSB 2 bits in order, and 2 bits corresponding to the LSB are transmitted through the DMRS of the PBCH.

(2) When the maximum number of SS blocks is 8: The SS block index is indicated through LSB 3 bits in order, and the corresponding 3 bits are transmitted through the DMRS of the PBCH.

(3) When the maximum number of SS blocks is 64: As illustrated in FIG. 22, the index in the SS block group may be indicated through LSB 3 bits in order, and 3 bits corresponding to the LSB may be transmitted through the DMRS of the PBCH. In addition, the index of the SS block group can be indicated by 3 bits of the 4th to 6th in order from the LSB, and 3 bits of the corresponding 4th to 6th may be transmitted to the MIB of the PBCH or may be indicated through different PBCH scrambling sequences (scrambling sequence) or sequence shift (sequence shift). That is, SS block index (0 ˜63)=2̂(p1)+8×2̂(p2). Here, p1 is the SS block index in the SS block group (0 to 7), and p2 is the SS block group index (0 to 7). Also, a ̂b means squaring a by b.

In addition, FIG. 22 disclosed in the present disclosure does not show the location of the SS block actually transmitted in physical form, but shows only the sequence of a logical SS block.

When the DMRS of the PBCH transmits only 2 bits information, the index in the SS block group may be indicated in the same scheme, that is, in order through LSB 2 bits, and the index of the SS block group is indicated in order from LSB through 4 bits of the 3rd to 6th.

The base station may indicate to the terminal whether the neighbor cell and the serving cell are synchronized. The base station may transmit the synchronization indication information with the neighboring cell provided to the terminal to the terminal through the RRC message related to measurement such as a measurement report.

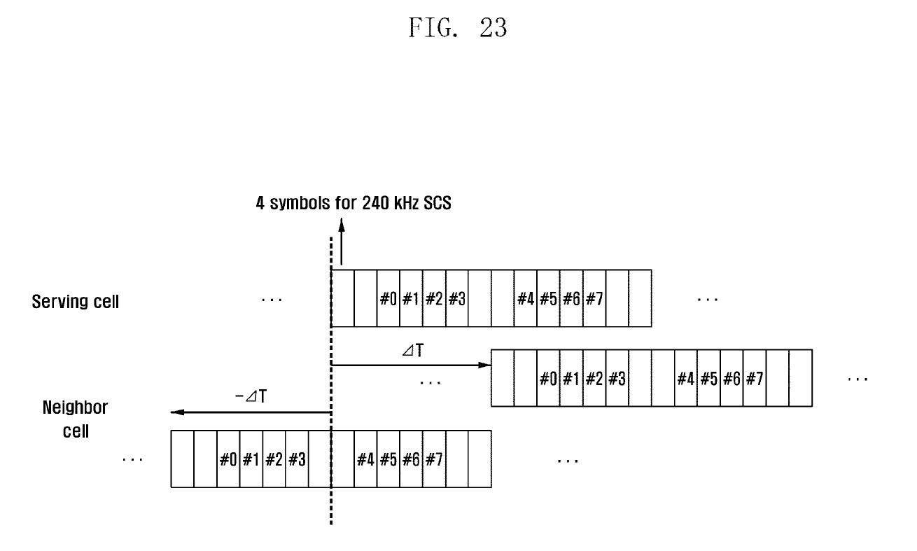

FIG. 23 is a diagram showing an inter-cell synchronization level according to an embodiment of the present disclosure.

Prior to referring to FIG. 23, the synchronization indication information with neighbor cells provided to the terminal may be at least one of the following (1) to (7), and may vary according to the SCS of the frequency band or the SS block.

(1) It is possible to indicate that inter-cell synchronization is consistent or inconsistent within half (Lcp/2) of the SCS reference CP length of the SS block, that is, +Lcp/2 and −Lcp/2.

(2) It is possible to indicate that inter-cell synchronization is consistent or inconsistent within half (Lsym/2) of the SCS reference CP length of the SS block, that is, +Lsym/2 and −Lsym/2.

(3) It is possible to indicate that inter-cell synchronization is consistent or inconsistent within half (Lcp/2) of the SCS reference CP length of the SS block (4 symbols based on SCS), that is, +Lblock/2 and −Lblock/2.

(4) The terminal can indicate that measurement can or can not be performed using at least two symbols in the SS block, i.e., PBCH (DMRS) and SSS.

(5) It is possible to indicate that the inter-cell synchronization is coincident or inconsistent within 2 slots (28 symbols) based on the SCS of the SS block including 4 SS blocks, that is, within +2 slots and −2 slots.

(6) (6) It is possible to indicate that the inter-cell synchronization is coincident or inconsistent within half of half frame, i.e., +2.5 ms and −2.5 ms.

(7) It is possible to indicate that the inter-cell synchronization is coincident or inconsistent within half of a frame, i.e., +5 ms and −5 ms.

The cases (1) to (7) illustrated above may simply indicate that the inter-cell synchronization is coincident or inconsistent, or the terminal may indicate whether the inter-cell synchronization can be assumed to be consistent within the corresponding numerical value.

In addition, in the case of the above (5), as shown in FIG. 23, the meaning of 4 SS blocks is 8t, that is, half the length of an SS block group (8 SS blocks) indicating the DMRS 3 bits. If the DMRS transmits only the 2 bits information of the SS block index, the inter-cell synchronization should indicate the consistency or inconsistency within 1 Slot. Here, the length of 2 slots is 0.25 ms based on SCS 120 kHz and 0.125 ms based on 240 kHz.

In the cases (6) and (7), since the terminal can not know the SS block index of the neighboring cell without PBCH decoding even if it receives an indication that the terminals are coincident, the base station may additionally indicate one of the above (1) to (5) information through the RRC message such as the handover command (HO command) during the handover. Alternatively, the terminal may be operated on the assumption of one of the above (1) to (5) without additional signaling. The indication or the terminal assumption may depend on the frequency band or the SCS of the SS block.

When the difference between the cells known by base station signaling or the terminal assumption is greater than the case of the above (5), the terminal should receive Timing index information through the PBCH decoding of the target cell during the handover.

Although the present disclosure has been described with various embodiments, various changes and modifications may be suggested to one skilled in the art. It is intended that the present disclosure encompass such changes and modifications as fall within the scope of the appended claims.

What is claimed is:

1. A method for transmitting a synchronization signals block (SS block) and a physical broadcasting signal block in a base station of a multi-beam based system, comprising:
identifying, by the base station, a number of bits of an index for indicating the synchronization signals block based on a total number of synchronization signals block (SS block) transmitted within an SS block burst set period; and
transmitting the index through DMRS of a physical broadcasting channel (PBCH) if the number of bits of the index is equal to or less than 3.

2. The method of claim 1, wherein the DMRS of the PBCH is configured to identify bits of the index using different scrambling sequences.

3. The method of claim 1, wherein the index of the synchronization signals bock includes different indexes for each beam of the base station.

4. The method of claim 1, further comprising:
allocating a higher 3 bits among the bits of the index to a master information block (MIB) if the number of bits of the index is 6 and transmitting the allocated higher 3 bits; and
transmitting a lower 3 bits among the bits of the index through the DMRS of the PBCH.

5. The method of claim 1, wherein a half-frame timing index and a system frame number information are further transmitted through the PBCH.

6. A base station apparatus for transmitting a synchronization signals block (SS block) and a physical broadcasting signal block in a multi-beam based system, comprising:
a base station transmitter configured to transmit a signal, including the synchronization signals block and a physical broadcasting channel (PBCH), into a base station area based on a multi beam; and
a processor configured to:
control the base station to identify a number of bits of an index for indicating the synchronization signals block based on a total number of synchronization signals block (SS block) transmitted within an SS block burst set period; and
transmit the index through DMRS of the physical broadcasting channel (PBCH) if the number of bits of the index is equal to or less than 3.

7. The base station apparatus of claim 6, wherein the processor is configured to allow the DMRS of the PBCH to identify bits of the index using different scrambling sequences.

8. The base station apparatus of claim 6, wherein the processor is configured to control the index of the synchronization signals block to have different indexes for each beam of the base station.

9. The base station apparatus of claim 6, wherein the processor is configured to:
perform a control to allocate a higher 3 bits among the bits of the index to a master information block (MIB), if the number of bits of the index is 6, and
transmit the allocated higher 3 bits and transmit a lower 3 bits among the bits of the index through the DMRS of the PBCH.

10. The base station apparatus of claim 6, wherein a half-frame timing index and a system frame number information are further transmitted through the PBCH.

11. A method for receiving a synchronization signals block (SS block) and a physical broadcasting signal block in a terminal of a multi-beam based system, comprising:
identifying a total number of synchronization signals block (SS block) transmitted within a synchronization signals block (SS block) burst set period based on a frequency accessing a base station;
receiving a physical broadcasting channel (PBCH) from the base station;
identifying whether a number of bits of a synchronization signals block identifier is equal to or less than 3 based on the total number of synchronization signals blocks; and
determining the synchronization signals block (SS block) identifier using a scrambling sequence of DMRS of the PBCH if the number of bits of a synchronization signals block identifier is equal to or less than 3.

12. The method of claim 11, wherein the DMRS of the PBCH includes different scrambling sequences for each synchronization signals block.

13. The method of claim 11, wherein an index of the synchronization signals bock includes different indexes for each beam of the base station.

14. The method of claim 11, further comprising:
determining, by a master information block (MIB) of the received PBCH, a higher 3 bits among the bits of an index if the number of bits of the index is 6, transmitting the determined higher 3 bits; and
determining a lower 3 bits among the bits of the index using a scrambling sequence of the DMRS of the received PBCH.

15. The method of claim 11, wherein a half-frame timing index and a system frame number information are further identified from information included in the received PBCH.

16. A terminal apparatus for receiving a synchronization signals block (SS block) and a physical broadcasting signal block in a multi-beam based system, comprising:
a terminal transmitter configured to receive a signal including the synchronization signals block and a physical broadcasting channel (PBCH); and
a processor configured to:
identify a total number of synchronization signals block (SS block) transmitted within a synchronization signals block (SS block) burst set period based on a frequency accessing a base station;
control the terminal transmitter to receive the PBCH from the base station,
identify whether a number of bits of a synchronization signals block identifier is equal to or less than 3 based on the total number of synchronization signals blocks, and
determine the synchronization signals block (SS block) identifier using a scrambling sequence of a DMRS of the PBCH if the number of bits of a synchronization signals block identifier is equal to or less than 3.

17. The terminal apparatus of claim 16, wherein the DMRS of the PBCH includes different scrambling sequences for each synchronization signals block.

18. The terminal apparatus of claim 16, wherein an index of the synchronization signals bock includes different indexes for each beam of the base station.

19. The terminal apparatus of claim 16, wherein the processor is configured to:
allow a master information block (MIB) of the received PBCH to determine a higher 3 bits among the bits of an index to if the number of bits of the index is 6, control the terminal transmitter to transmit the determined higher 3 bits, and
determine a lower 3 bits among the bits of the index using a scrambling sequence of the DMRS of the PBCH.

20. The terminal apparatus of claim 16, wherein the processor is configured to further identify a half-frame timing index and a system frame number information from information included in the received PBCH.
